(19) United States
(12) Patent Application Publication
(10) Pub. No.: US 2013/0182967 A1
(43) Pub. Date: Jul. 18, 2013

(54) IMAGE PROCESSING DEVICE AND IMAGE PROCESSING METHOD

(71) Applicant: Kazushi Sato, Kanagawa (JP)

(72) Inventor: Kazushi Sato, Kanagawa (JP)

(21) Appl. No.: 13/824,973

(22) PCT Filed: Sep. 6, 2011
(86) PCT No.: PCT/JP2011/070233

§ 371 Date: Mar. 18, 2013

(30) Foreign Application Priority Data
Oct. 1, 2010 (JP) 2010-224349

(51) Int. Cl. G06T 9/00

(52) U.S. Cl. CPC G06T 9/004
USPC 382/238

(57) ABSTRACT

There is provided an image processing device including a sorting section that sorts pixel values of common pixel positions in adjacent sub-blocks included in a block in an image in a manner that the pixel values included in the block are adjacent to one another after the sorting, and a prediction section generates a predicted pixel value for a pixel of a first pixel position of the sub-block using the pixel values sorted by the sorting section and a reference pixel value in the image corresponding to the first pixel position.

### TECHNICAL FIELD

The present disclosure relates to an image processing device, and an image processing method.

2. Background Art

Conventionally, a compression technology is widespread that has its object to effectively transmit or accumulate digital images, and that compresses the amount of information of an image by motion compensation and orthogonal transform such as discrete cosine transform, for example, by using redundancy unique to the image. For example, an image encoding device and an image decoding device conforming to a standard technology such as H.26x standards developed by ITU-T or MPEG-y standards developed by MPEG (Moving Picture Experts Group) are widely used in various scenes, such as accumulation and distribution of images by a broadcaster and reception and accumulation of images by a general user.

MPEG2 (ISO/IEC 13818-2) is one of MPEG-y standards defined as a general-purpose image encoding method. MPEG2 is capable of handling both interlaced scanning images and non-interlaced images, and targets high-definition images, in addition to digital images in standard resolution. MPEG2 is currently widely used in a wide range of applications including professional uses and consumer uses. According to MPEG2, for example, by allocating a bit rate of 4 to 8 Mbps to an interlaced scanning image in standard resolution of 720×480 pixels and a bit rate of 18 to 22 Mbps to an interlaced scanning image in high resolution of 1920×1088 pixels, both a high compression ratio and a desirable image quality can be realized.

MPEG2 was primarily for high-quality encoding suitable for broadcasting use, and did not handle a bit rate lower than MPEG1, that is, a high compression ratio. However, with the spread of mobile terminals of recent years, the demand for an encoding method enabling a high compression ratio is increasing. Accordingly, standardization of an MPEG4 encoding method was newly promoted. With regard to an image encoding method which is a part of the MPEG4 encoding method, its standards were accepted as an international standard (ISO/IEC 14496-2) in December 1998.

The H.26x standards (ITU-T Q6/16 VCEG) are standards developed initially with the aim of performing encoding that is suitable for communications such as video telephones and video conferences. The H.26x standards are known to require a large computation amount for encoding and decoding, but to be capable of realizing a higher compression ratio, compared with the MPEG-y standards. Furthermore, with Joint Model of Enhanced-Compression Video Coding, which is a part of the activities of MPEG4, a standard allowing realization of a higher compression ratio by adopting a new function while being based on the H.26x standards is developed. This standard was made an international standard under the names of H.264 and MPEG-4 Part 10 (Advanced Video Coding; AVC) in March 2003.

One important technique in the image encoding method describe above is in-screen prediction, that is, intra prediction. Intra prediction is a technique of using a correlation between adjacent blocks in an image and predicting the pixel value of a certain block from the pixel value of another block that is adjacent to thereby reduce the amount of information to be encoded. With an image encoding method before MPEG4, only the DC component and the low frequency component of an orthogonal transform coefficient were the targets of intra prediction, but with H.264/AVC, intra prediction is possible for all the pixel values. By using intra prediction, a significant increase in the compression ratio can be expected for an image where the change in the pixel value is gradual, such as an image of the blue sky, for example.

In H.264/AVC, intra prediction may be performed with a block of 4×4 pixels, 8×8 pixels or 16×16 pixels, for example, as one unit of processing. Also, Non-Patent Literature 1 mentioned below proposes intra prediction that is based on an extended block size, taking a block of 32×32 pixels or 64×64 pixels as a unit of processing.

Incidentally, in a situation where a digital image is possibly reproduced by various terminals with different processing performance, display resolutions and bands, partial decoding is preferably enabled. Partial decoding generally means to partially decode encoded data of a high-resolution image to thereby obtain only a low-resolution image. That is, if encoded data that can be partially decoded is supplied, a terminal with relatively high processing performance may reproduce the entire high-resolution image, while a terminal with low processing performance (or a low-resolution display) reproduces only a low-resolution image.

### CITATION LIST

### Non-Patent Literature

Non-Patent Literature 1: Sung-Chang Lim, Hahyun Lee, Jinho Lee. Jongho Kim, Haechul Choi, Seyoon Jeong, Jin Soo Choi, “Intra coding using extended block size” (VCEG-AL28, July 2009)

### SUMMARY OF INVENTION

### Technical Problem

However, with an existing intra prediction scheme, a plurality of prediction modes based on various correlations between pixels in the same image is used. Accordingly, if a pixel in an image is not decoded, it becomes difficult to decode other pixels correlated with the pixel that is not decoded. That is, the existing intra prediction scheme is a scheme that in itself requires a great amount of computation from a terminal, but is not suitable for partial decoding, and as a result, the scheme does not satisfy needs for reproduction of a digital image by various terminals.

Accordingly, the technology according to the present disclosure aims to provide an image processing device and an image processing method for realizing an intra prediction scheme that enables partial decoding.

### Solution to Problem

According to an embodiment of the present disclosure, there is provided an image processing device including a sorting section that sorts pixel values of common pixel positions in adjacent sub-blocks included in a block in an image in a manner that the pixel values included in the block are adjacent to one another after the sorting; and a prediction section that generates a predicted pixel value for a pixel of a first pixel position of the sub-block using the pixel values sorted by the sorting section and a reference pixel value in the image corresponding to the first pixel position.

The image processing device mentioned above may be typically realized as an image encoding device that encodes an image.

Further, the prediction section may generate the predicted pixel value for the pixel of the first pixel position without using a correlation with a pixel value of another pixel position.

Further, the prediction section may generate a predicted pixel value for a pixel of a second pixel position according to a prediction mode that is based on a correlation with the pixel value of the first pixel position.

Further, the prediction section may generate a predicted pixel value for a pixel of a third pixel position in parallel with generation of the predicted pixel value for the pixel of the second pixel position, according to the prediction mode that is based on a correlation with the pixel value of the first pixel position.

Further, the prediction section may generate a predicted pixel value for a pixel of a fourth pixel position in parallel with generation of the predicted pixel values for the pixels of the second pixel position and the third pixel position, according to the prediction mode that is based on a correlation with the pixel value of the first pixel position.

Further, the prediction section may generate the predicted pixel value for the pixel of the fourth pixel position according to a prediction mode that is based on a correlation with the pixel values of the second pixel position and the third pixel position.

Further, in a case where a prediction mode selected at a time of generating the predicted pixel value for the pixel of the first pixel position is allowed to be estimated from a prediction mode selected at a time of generating a predicted pixel value of the first pixel position of another block that is already encoded, the prediction section may generate information indicating that the prediction mode for the first pixel position is allowed to be estimated.

Further, the prediction mode that is based on a correlation with the pixel value of the first pixel position may be a prediction mode of generating the predicted pixel value by phase-shifting the pixel value of the first pixel position.

Further, according to another embodiment of the present disclosure, there is provided an image processing method for processing an image including sorting pixel values of common pixel positions in adjacent sub-blocks included in a block in an image in a manner that the pixel values included in the block are adjacent to one another after the sorting, and generating a predicted pixel value for a pixel of a first pixel position of the sub-block using the sorted pixel values and a reference pixel value in the image corresponding to the first pixel position.

Further, according to another embodiment of the present disclosure, there is provided an image processing device including a sorting section that sorts pixel values of reference pixels corresponding to respective common pixel positions in adjacent sub-blocks included in a block in an image in a manner that the pixel values of the reference pixels in the image are adjacent to one another after the sorting, and a prediction section that generates a predicted pixel value for a pixel of a first pixel position of the sub-block using the pixel values of the reference pixels sorted by the sorting section.

The image processing device mentioned above may be typically realized as an image decoding device that decodes an image.

Further, the prediction section may generate the predicted pixel value for the pixel of the first pixel position without using a correlation with a pixel value of a reference pixel corresponding to another pixel position.

Further, the prediction section may generate a predicted pixel value for a pixel of a second pixel position according to a prediction mode that is based on a correlation with the pixel value of the first pixel position.

Further, the prediction section may generate a predicted pixel value for a pixel of a third pixel position in parallel with generation of the predicted pixel value for the pixel of the second pixel position, according to the prediction mode that is based on a correlation with the pixel value of the first pixel position.

Further, the prediction section may generate a predicted pixel value for a pixel of a fourth pixel position in parallel with generation of the predicted pixel values for the pixels of the second pixel position and the third pixel position, according to the prediction mode that is based on a correlation with the pixel value of the first pixel position.

Further, the prediction section may generate the predicted pixel value for the pixel of the fourth pixel position according to a prediction mode that is based on a correlation with the pixel values of the second pixel position and the third pixel position.

Further, in a case where it is indicated that a prediction mode is allowed to be estimated for the first pixel position, the prediction section may estimate the prediction mode for generating the predicted pixel value for the pixel of the first pixel position from a prediction mode selected at a time of generating a predicted pixel value of the first pixel position of another block that is already encoded.

Further, the prediction mode that is based on a correlation with the pixel value of the first pixel position may be a prediction mode of generating the predicted pixel value by phase-shifting the pixel value of the first pixel position.

Further, the image processing device may further include a determination section that determines whether to partially decode the image or not. In a case where the determination section determines that the image is to be partially decoded, the prediction section does not necessarily generate a predicted pixel value of at least one pixel position excluding the first pixel position.

Further, according to another embodiment of the present disclosure, there is provided an image processing method for processing an image including sorting pixel values of reference pixels corresponding to respective common pixel positions in adjacent sub-blocks included in a block in an image in a manner that the pixel values of the reference pixels in the image are adjacent to one another after the sorting, and generating a predicted pixel value for a pixel of a first pixel position of the sub-block using the sorted pixel values of the reference pixels.

### Advantageous Effects of Invention

As described above, according to the image processing device and the image processing method of the present disclosure, an intra prediction scheme that enables partial decoding can be realized.

### BRIEF DESCRIPTION OF DRAWINGS

FIG. 1 is a block diagram showing an example of a configuration of an image encoding device according to an embodiment.

FIG. 2 is a block diagram showing an example of a detailed configuration of an intra prediction section of the image encoding device of the embodiment.

FIG. 3 is a first explanatory diagram for describing an intra 4×4 prediction mode.

FIG. 4 is a second explanatory diagram for describing the intra 4×4 prediction mode.

FIG. 5 is a third explanatory diagram for describing the intra 4×4 prediction mode.

FIG. 6 is an explanatory diagram for describing an intra 8×8 prediction mode.

FIG. 7 is an explanatory diagram for describing an intra 16×16 prediction mode.

FIG. 8 is an explanatory diagram for describing a pixel and a reference pixel in a macro block.

FIG. 9 is an explanatory diagram for describing an example of sorting of encoding target pixel values.

FIG. 10 is an explanatory diagram for describing an example of sorting of reference pixel values.

FIG. 11 is an explanatory diagram for describing an example of parallel processing by the intra prediction section.

FIG. 12 is a block diagram showing another example of the detailed configuration of the intra prediction section of the image encoding device according to the embodiment.

FIG. 13 is an explanatory diagram for describing another example of the parallel processing by the intra prediction section.

FIG. 14 is an explanatory for describing another example of sorting of encoding target pixel values.

FIG. 15A is a first explanatory diagram for describing a new prediction mode.

FIG. 15B is a second explanatory diagram for describing the new prediction mode.

FIG. 15C is a third explanatory diagram for describing the new prediction mode.

FIG. 15D is a fourth explanatory diagram for describing the new prediction mode.

FIG. 16 is an explanatory diagram for describing mirror processing and holding processing of pixel values.

FIG. 17 is an explanatory diagram for describing estimation of a prediction direction.

FIG. 18 is a flow chart showing an example of a flow of an intra prediction process at the time of encoding according to an embodiment.

FIG. 19 is a flow chart showing another example of the intra prediction process at the time of encoding according to the embodiment.

FIG. 20 is a block diagram showing an example of a configuration of an image decoding device according to an embodiment.

FIG. 21 is a block diagram showing an example of a detailed configuration of an intra prediction section of the image decoding device according to the embodiment.

FIG. 22 is a block diagram showing another example of the detailed configuration of the intra prediction section of the image decoding device according to the embodiment.

FIG. 23 is a flow chart showing an example of a flow of an intra prediction process at the time of decoding according to an embodiment.

FIG. 24 is a flow chart showing another example of the flow of the intra prediction process at the time of decoding according to the embodiment.

FIG. 25 is a block diagram showing an example of a schematic configuration of a television.

FIG. 26 is a block diagram showing an example of a schematic configuration of a mobile phone.

FIG. 27 is a block diagram showing an example of a schematic configuration of a recording/reproduction device.

FIG. 28 is a block diagram showing an example of a schematic configuration of an image capturing device.

### DESCRIPTION OF EMBODIMENTS

Hereinafter, preferred embodiments of the present invention will be described in detail with reference to the appended drawings. Note that, in this specification and the drawings, elements that have substantially the same function and structure are denoted with the same reference signs, and repeated explanation is omitted.

Furthermore, the “Description of Embodiments” will be described in the order mentioned below.

1. Example Configuration of Image Encoding Device According to an Embodiment

2. Flow of Process at the Time of Encoding According to an Embodiment

3. Example Configuration of Image Decoding Device According to an Embodiment

4. Flow of Process at the Time of Decoding According to an Embodiment

5. Example Application

6. Summary

### 1. Example Configuration of Image Encoding Device According to an Embodiment

[1-1. Example of Overall Configuration]

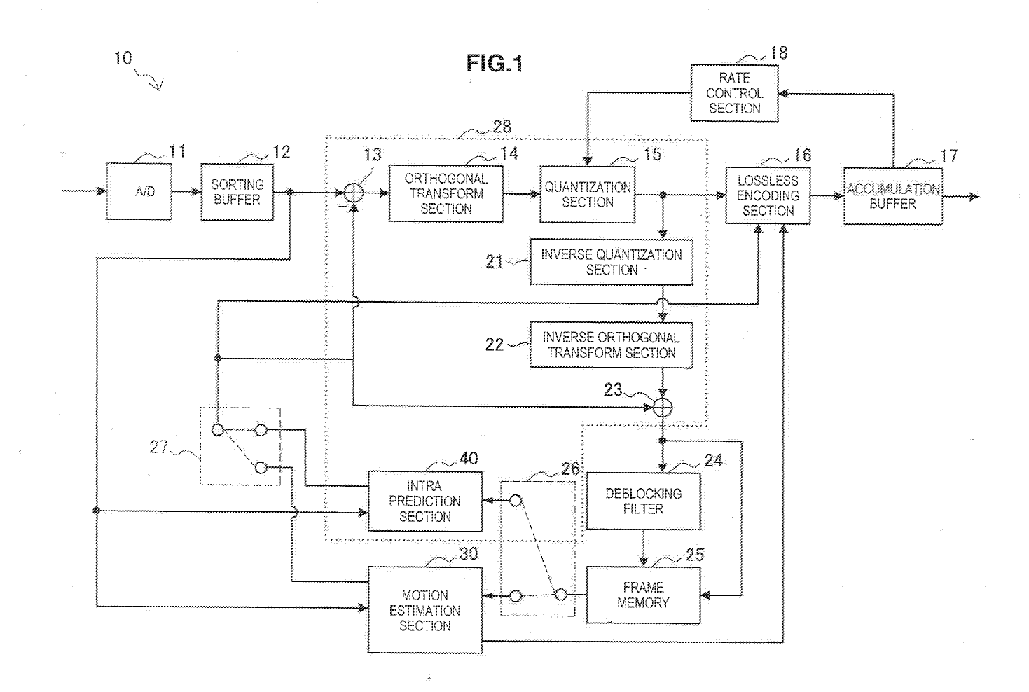

FIG. 1 is a block diagram showing an example of a configuration of an image encoding device 10 according to an embodiment. Referring to FIG. 1, the image encoding device 10 includes an A/D (Analogue to Digital) conversion section 11, a sorting buffer 12, a subtraction section 13, an orthogonal transform section 14, a quantization section 15, a lossless encoding section 16, an accumulation buffer 17, a rate control section 18, an inverse quantization section 21, an inverse orthogonal transform section 22, an addition section 23, a deblocking filter 24, a frame memory 25, selectors 26 and 27, a motion estimation section 30 and an intra prediction section 40.

The A/D conversion section 11 converts an image signal input in an analogue format into image data in a digital format, and outputs a series of digital image data to the sorting buffer 12.

The sorting buffer 12 sorts the images included in the series of image data input from the A/D conversion section 11. After sorting the images according to the a GOP (Group of Pictures) structure according to the encoding process, the sorting buffer 12 outputs the image data which has been sorted to the subtraction section 13, the motion estimation section 30 and the intra prediction section 40.

The image data input from the sorting buffer 12 and predicted image data input by the motion estimation section 30 or the intra prediction section 40 described later are supplied to the subtraction section 13. The subtraction section 13 calculates predicted error data which is a difference between the image data input from the sorting buffer 12 and the predicted image data and outputs the calculated predicted error data to the orthogonal transform section 14.

The orthogonal transform section 14 performs orthogonal transform on the predicted error data input from the subtraction section 13. The orthogonal transform to be performed by the orthogonal transform section 14 may be discrete cosine transform (DCT) or Karhunen-Loeve transform, for example. The orthogonal transform section 14 outputs transform coefficient data acquired by the orthogonal transform process to the quantization section 15.

The transform coefficient data input from the orthogonal transform section 14 and a rate control signal from the rate control section 18 described later are supplied to the quantization section 15. The quantization section 15 quantizes the transform coefficient data, and outputs the transform coefficient data which has been quantized (hereinafter, referred to as quantized data) to the lossless encoding section 16 and the inverse quantization section 21. Also, the quantization section 15 switches a quantization parameter (a quantization scale) based on the rate control signal from the rate control section 18 to thereby change the bit rate of the quantized data to be input to the lossless encoding section 16.

The quantized data input from the quantization section 15 and information about inter prediction or intra prediction input from the motion estimation section 30 or the intra prediction section 40 described later are supplied to the lossless encoding section 16. The information about inter prediction may include prediction mode information, motion vector information, reference image information and the like, for example. Also, the information about intra prediction may include prediction mode information indicating the size of a prediction unit, which is a unit of processing of intra prediction, and an optimal prediction direction (prediction mode) for each prediction unit.

The lossless encoding section 16 generates an encoded stream by performing a lossless encoding process on the quantized data. The lossless encoding by the lossless encoding section 16 may be variable-length coding or arithmetic coding, for example. Furthermore, the lossless encoding section 16 multiplexes the information about inter prediction or the information about intra prediction mentioned above to the header of the encoded stream (for example, a block header, a slice header or the like). Then, the lossless encoding section 16 outputs the generated encoded stream to the accumulation buffer 17.

The accumulation buffer 17 temporarily stores the encoded stream input from the lossless encoding section 16 using a storage medium, such as a semiconductor memory. Then, the accumulation buffer 17 outputs the accumulated encoded stream at a rate according to the band of a transmission line (or an output line from the image encoding device 10).

The rate control section 18 monitors the free space of the accumulation buffer 17. Then, the rate control section 18 generates a rate control signal according to the free space on the accumulation buffer 17, and outputs the generated rate control signal to the quantization section 15. For example, when there is not much free space on the accumulation buffer 17, the rate control section 18 generates a rate control signal for lowering the bit rate of the quantized data. Also, for example, when the free space on the accumulation buffer 17 is sufficiently large, the rate control section 18 generates a rate control signal for increasing the bit rate of the quantized data.

The inverse quantization section 21 performs an inverse quantization process on the quantized data input from the quantization section 15. Then, the inverse quantization section 21 outputs transform coefficient data acquired by the inverse quantization process to the inverse orthogonal transform section 22.

The inverse orthogonal transform section 22 performs an inverse orthogonal transform process on the transform coefficient data input from the inverse quantization section 21 to thereby restore the predicted error data. Then, the inverse orthogonal transform section 22 outputs the restored predicted error data to the addition section 23.

The addition section 23 adds the restored predicted error data input from the inverse orthogonal transform section 22 and the predicted image data input from the motion estimation section 30 or the intra prediction section 40 to thereby generate decoded image data. Then, the addition section 23 outputs the generated decoded image data to the deblocking filter 24 and the frame memory 25.

The deblocking filter 24 performs a filtering process for reducing block distortion occurring at the time of encoding of an image. The deblocking filter 24 filters the decoded image data input from the addition section 23 to remove the block distortion, and outputs the decoded image data after filtering to the frame memory 25.

The frame memory 25 stores, using a storage medium, the decoded image data input from the addition section 23 and the decoded image data after filtering input from the deblocking filter 24.

The selector 26 reads the decoded image data after filtering which is to be used for inter prediction from the frame memory 25, and supplies the decoded image data which has been read to the motion estimation section 30 as reference image data. Also, the selector 26 reads the decoded image data before filtering which is to be used for intra prediction from the frame memory 25, and supplies the decoded image data which has been read to the intra prediction section 40 as reference image data.

In the inter prediction mode, the selector 27 outputs predicted image data which is a result of inter prediction output from the motion estimation section 30 to the subtraction section 13, and also, outputs the information about inter prediction to the lossless encoding section 16. Furthermore, in the intra prediction mode, the selector 27 outputs predicted image data which is a result of intra prediction output from the intra prediction section 40 to the subtraction section 13, and also, outputs the information about intra prediction to the lossless encoding section 16.

The motion estimation section 30 performs an inter prediction process (inter-frame prediction process) defined by H.264/AVC, based on encoding target image data input from the sorting buffer 12 and the decoded image data supplied via the selector 26. For example, the motion estimation section 30 evaluates a prediction result of each prediction mode using a predetermined cost function. Then, the motion estimation section 30 selects a prediction mode by which a cost function value is the smallest, that is, a prediction mode by which the compression ratio is the highest, as the optimal prediction mode. Also, the motion estimation section 30 generates predicted image data according to the optimal prediction mode. Then, the motion estimation section 30 outputs, to the selector 27, the information about inter prediction including the prediction mode information indicating the selected optimal prediction mode, and the predicted image data.

The intra prediction section 40 performs an intra prediction process for each macro block set in an image based on the encoding target image data input from the sorting buffer 12 and the decoded image data as reference image data supplied from the frame memory 25. The intra prediction process of the intra prediction section will be described later in detail.

As it will described later, the intra prediction process of the intra prediction section 40 can be parallelized using a plurality of processing branches. With the parallelization of the intra prediction process, the processing, related to the intra prediction mode, of the subtraction section 13, the orthogonal transform section 14, the quantization section 15, the inverse quantization section 21, the inverse orthogonal transform section 22 and the addition section 23 described above may also be parallelized. In this case, as shown in FIG. 1, the subtraction section 13, the orthogonal transform section 14, the quantization section 15, the inverse quantization section 21, the inverse orthogonal transform section 22, the addition section 23 and the intra prediction section 40 form a parallel processing segment 28. Also, each section in the parallel processing segment 28 includes a plurality of processing branches. Each section in the parallel processing segment 28 may, while performing parallel processing in the intra prediction mode using a plurality of processing branches, use only one processing branch in the inter prediction mode.

[1-2. Example Configuration of Intra Prediction Section]

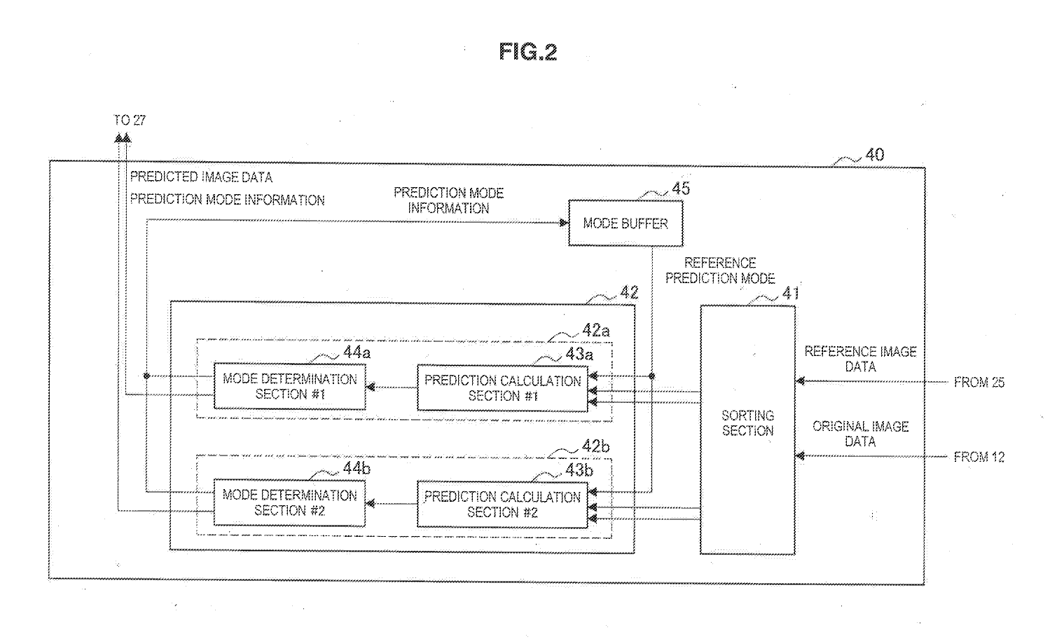

FIG. 2 is a block diagram showing an example of a detailed configuration of the intra prediction section 40 of the image encoding device 10 shown in FIG. 1. Referring to FIG. 2, the intra prediction section 40 includes a sorting section 41, a prediction section 42 and a mode buffer 45. Also, the prediction section 42 includes a first prediction section 42a and a second prediction section 42b that are two processing branches arranged in parallel.

The sorting section 41 reads the pixel values included in a macro block in an image (an original image) line by line, for example, and sorts the pixel values according to a predetermined rule. Then, the sorting section 41 outputs the sorted pixel values to the first prediction section 42a or the second prediction section 42b according to the pixel positions.

Furthermore, the sorting section 41 sorts reference pixel values included in reference image data supplied from the frame memory 25 according to a predetermined rule. The reference image data supplied from the frame memory 25 to the intra prediction section 40 is data of an already encoded portion of an image same as the encoding target image. Then, the sorting section 41 outputs reference pixel values after sorting to the first prediction section 42a or the second prediction section 42b respectively according to the pixel positions.

Accordingly, in the present embodiment, the sorting section 41 serves as sorting means for sorting pixel values of an original image and reference pixel values. The rule of sorting the pixel values of the sorting section 41 will be described later with examples. Furthermore, the sorting section 41 also serves as inverse multiplexing means for distributing sorted pixel values to respective processing branches.

The first prediction section 42a and the second prediction section 42b generate predicted pixel values for an encoding target macro block using the pixel values of the original image and the reference pixel values which have been sorted by the sorting section 41.

More specifically, the first prediction section 42a includes a first prediction calculation section 43a and a first mode determination section 44a. The first prediction calculation section 43a calculates a plurality of predicted pixel values from the reference pixel values sorted by the sorting section 41, according to a plurality of prediction modes as candidates. A prediction mode mainly identifies the direction from reference pixels used for prediction to encoding target pixels (referred to as a prediction direction). By specifying one prediction mode, a reference pixel to be used for calculation of a predicted pixel value and a calculation formula for the predicted pixel value may be identified for an encoding target pixel. Note that in the present embodiment, the candidates of the prediction mode vary depending upon which part of the series of pixel values sorted by the sorting section 41. Examples of prediction modes that may be used at the time of intra prediction according to the present embodiment will be described later with reference to examples. The first mode determination section 44a evaluates the candidates of the plurality of prediction modes using a predetermined cost function that is based on the pixel values of the original image sorted by the sorting section 41, the predicted pixel values calculated by the first prediction calculation section 43a, an expected bit rate and the like. Then, the first mode determination section 44a selects a prediction mode by which the cost function value is the smallest, that is, a prediction mode by which the compression ratio is the highest, as the optimal prediction mode. After such a process, the first prediction section 42a outputs prediction mode information indicating the optimal prediction mode selected by the first mode determination section 44a to the mode buffer 45, and also, outputs the prediction mode information and predicted image data including corresponding predicted pixel values to the selector 27.

The second prediction section 42b includes a second prediction calculation section 43b and a second mode determination section 44b. The second prediction calculation section 43b calculates a plurality of predicted pixel values from the reference pixel values sorted by the sorting section 41, according to a plurality of prediction modes as candidates. The second mode determination section 44b evaluates the candidates of the plurality of prediction modes using a predetermined cost function that is based on the pixel values of the original image sorted by the sorting section 41, the predicted pixel values calculated by the second prediction calculation section 43b, an expected bit rate and the like. Then, the second mode determination section 44b selects a prediction mode by which the cost function value is the smallest as the optimal prediction mode. After such a process, the second prediction section 42b outputs prediction mode information indicating the optimal prediction mode selected by the second mode determination section 44b to the mode buffer 45, and also, outputs the prediction mode information and predicted image data including corresponding predicted pixel values to the selector 27.

The mode buffer 45 temporarily stores the prediction mode information input from the first prediction section 42a and the second prediction section 42b using a storage medium. The prediction mode information stored by the mode buffer 45 is referred to as a reference prediction mode at the time of estimation of a prediction direction by the first prediction section 42a and the second prediction section 42b. Estimation of a prediction direction is a technique of estimating a prediction mode for an encoding target block from a prediction mode set for a reference block by focusing on that the optimal prediction direction (the optimal prediction mode) is the same for adjacent blocks with a high possibility. A prediction mode number of a block for which an appropriate prediction direction can be decided by predicting the prediction direction is not encoded, and the bit rate necessary for encoding may be reduced. Estimation of a prediction direction in the present embodiment will be further described later.

[1-3. Example of Existing Prediction Mode]

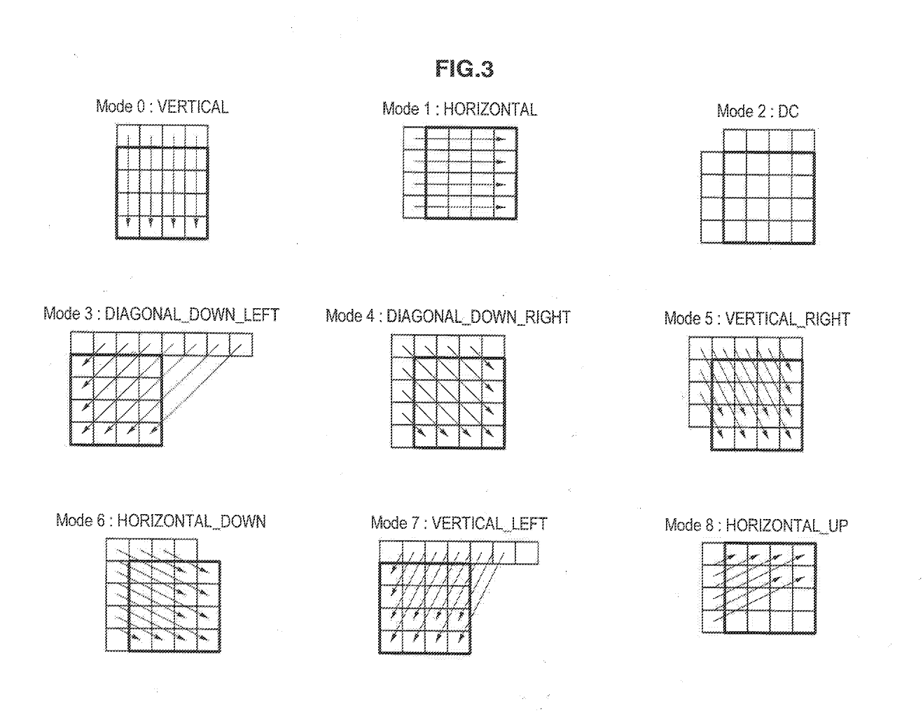

Next, examples of a prediction mode with an existing intra prediction scheme will be given using FIGS. 3 to 7.

### (1) Intra 4>4 Prediction Mode

FIGS. 3 to 5 are explanatory diagrams for describing candidates of a prediction mode in an intra 4×4 prediction mode.

Referring to FIG. 3, nine types of prediction modes (Mode 0 to Mode 8) that may be used in the intra 4×4 prediction mode are shown. Also, in FIG. 4, prediction directions corresponding to respective mode numbers are schematically shown.

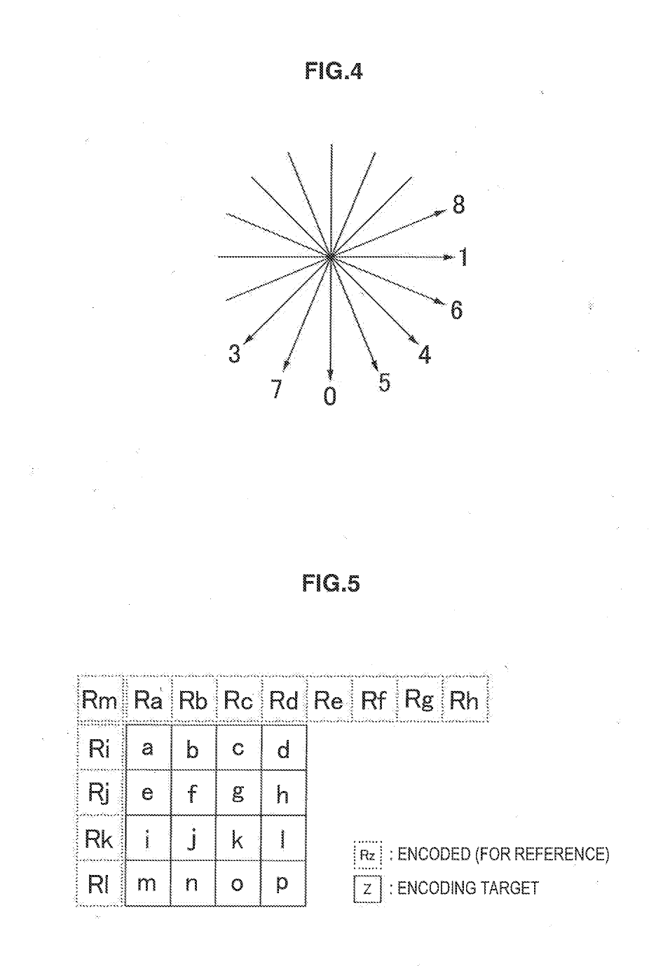

In FIG. 5, each of lower case alphabets a to p indicates a pixel value in an encoding target prediction unit of 4×4 pixels. The Rz (z=a, b, . . . , m) around the encoding target prediction unit indicates an already encoded reference pixel value. In the following, calculation of a predicted pixel value in each prediction mode illustrated in FIG. 3 will be described using these encoding target pixel values a to p and reference pixel values Ra to Rm.

### (1-1) Example of Existing Predication Mode for Mode 0: Vertical

The prediction direction in Mode 0 is a vertical direction. Mode 0 may be used in a case the reference pixel values Ra, Rb, Rc and Rd are available. Each predicted pixel value is calculated as below:

a=e=i=m=Ra

b=f=j=n=Rb

c=g=k=o=Rc

d=h=l=p=Rd

### (1-2) Mode 1: Horizontal

The prediction direction in Mode 1 is horizontal. Mode 1 may be used in a case the reference pixel values Ri, Rj, Rk and Rl are available. Each predicted pixel value is calculated as below:

a=b=c=d=Ri

e=f=g=h=Rj

i=j=k=l=Rk

m=n=o=p=Rl

### (1-3) Mode 2: DC

Mode 2 indicates DC prediction (average value prediction). In a case all of reference pixel values Ra to Rd and Ri to Rl are available, each predicted pixel value is calculated as below:

Each predicted pixel value=(Ra+Rb+Rc+Rd+Ri+Rj+Rk+Rl+4)>>3

In a case none of the reference pixel values Ri to Rl are available, each predicted pixel value is calculated as below:

Each predicted pixel value=(Ra+Rb+Rc+Rd+2)>>2

In a case none of the reference pixel values Ra to Rd are available, each predicted pixel value is calculated as below:

Each predicted pixel value=(Ri+Rj+Rk+Rl+2)>>2

In a case none of the reference pixel values Ra to Rd and Ri to Rl are available, each predicted pixel value is calculated as below:

Each predicted pixel value=128

### (1-4) Mode 3: Diagonal_Down_Left

The prediction direction in Mode 3 is diagonal down left. Mode 3 may be used in a case the reference pixel values Ra to Rh are available. Each predicted pixel value is calculated as below:

a=(Ra+2Rb+Rc+2)>>2

b=e=(Rb+2Rc+Rd+2)>>2

c=f=i=(Rc+2Rd+Re+2)>>2

d=g=j=m=(Rd+2Re+Rf+2)>>2

h=k=n=(Re+2Rf+Rg+2)>>2

l=o=(Rf+2Rg+Rh+2)>>2

p=(Rg+3Rh+2)>>2

### (1-5) Mode 4: Diagonal_Down_Right

The prediction direction in Mode 4 is diagonal down right. Mode 4 may be used in a case the reference pixel values Ra to Rd and Ri to Rm are available. Each predicted pixel value is calculated as below:

m=(Rj+2Rk+Rl+2)>>2

i=n=(Ri+2Rj+Rk+2)>>2

e=j=o=(Rm+2Ri+Rj+2)>>2

a=f=k=p=(Ra+2Rm+Ri+2)>>2

b=g=l=(Rm+2Ra+Rb+2)>>2

c=h=(Ra+2Rb+Rc+2)>>2

d=(Rb+2Rc+Rd+2)>>2

### (1-6) Mode 5: Vertical_Right

The prediction direction in Mode 5 is vertical right. Mode 5 may be used in a case the reference pixel values Ra to Rd and Ri to Rm are available. Each predicted pixel value is calculated as below:

a=j=(Rm+Ra+1)>>1

b=k=(Ra+Rb+1)>>1

c=l=(Rb+Rc+1)>>1

d=(Rc+Rd+1)>>1

e=n=(Ri+2Rm+Ra+2)>>2

f=o=(Rm+2Ra+Rb+2)>>2

g=p=(Ra+2Rb+Rc+2)>>2

h=(Rb+2Rc+Rd+2)>>2

i=(Rm+2Ri+Rj+2)>>2

m=(Ri+2Rj+Rk+2)>>2

### (1-7) Mode 6: Horizontal_Down

The prediction direction in Mode 6 is horizontal down. Mode 6 may be used in a case the reference pixel values Ra to Rd and Ri to Rm are available. Each predicted pixel value is calculated as below:

a=g=(Rm+Ri+1)>>1

b=h=(Ri+2Rm+Ra+2)>>2

c=(Rm+2Ra+Rb+2)>>2

d=(Ra+2Rb+Rc+2)>>2

e=k=(Ri+Rj+1)>>1

f=l=(Rm+2Ri+Rj+2)>>2

i=o=(Rj+Rk+1)>>1

j=p=(Ri+2Rj+Rk+2)>>2

m=(Rk+Rl+1)>>1

n=(Rj+2Rk+Rl+2)>>2

### (1-8) Mode 7: Vertical_Left

The prediction direction in Mode 7 is vertical left. Mode 7 may be used in a case the reference pixel values Ra to Rg are available. Each predicted pixel value is calculated as below:

a=(Ra+Rb+1)>>1

b=i=(Rb+Rc+1)>>1

c=j=(Rc+Rd+1)>>1

d=k=(Rd+Re+1)>>1

l=(Re+Rf+1)>>1

e=(Ra+2Rb+Rc+2)>>2

f=m=(Rb+2Rc+Rd+2)>>2

g=n=(Rc+2Rd+Re+2)>>2

h=o=(Rd+2Re+Rf+2)>>2

p=(Re+2Rf+Rg+2)>>2

### (1-9) Mode 8: Horizontal_Up

The prediction direction in Mode 8 is horizontal up. Mode 8 may be used in a case the reference pixel values Ri to Rl are available. Each predicted pixel value is calculated as below:

a=(Ri+Rj+1)>>1

b=(Ri+2Rj+Rk+2)>>2

c=e=(Rj+Rk+1)>>1

d=f=(Rj+2Rk+Rl+2)>>2

g=i=(Rk+Rl+1)>>1

h=j=(Rk+3Rl+2)>>2

k=l=m=n=o=p=Rl

The calculation formulae of predicted pixel values in the nine types of prediction modes are the same as the calculation formulae of the intra 4×4 prediction mode defined by H.264/AVC. The first prediction calculation sections 43a of the first prediction section 42a and the second prediction calculation sections 43b of the second prediction section 42b in the intra prediction section 40 described above may calculate predicted pixel values corresponding to respective prediction modes based on the reference pixel values sorted by the sorting section 41 while taking the nine prediction modes as the candidates.

### (2) Intra 8×8 Prediction Mode

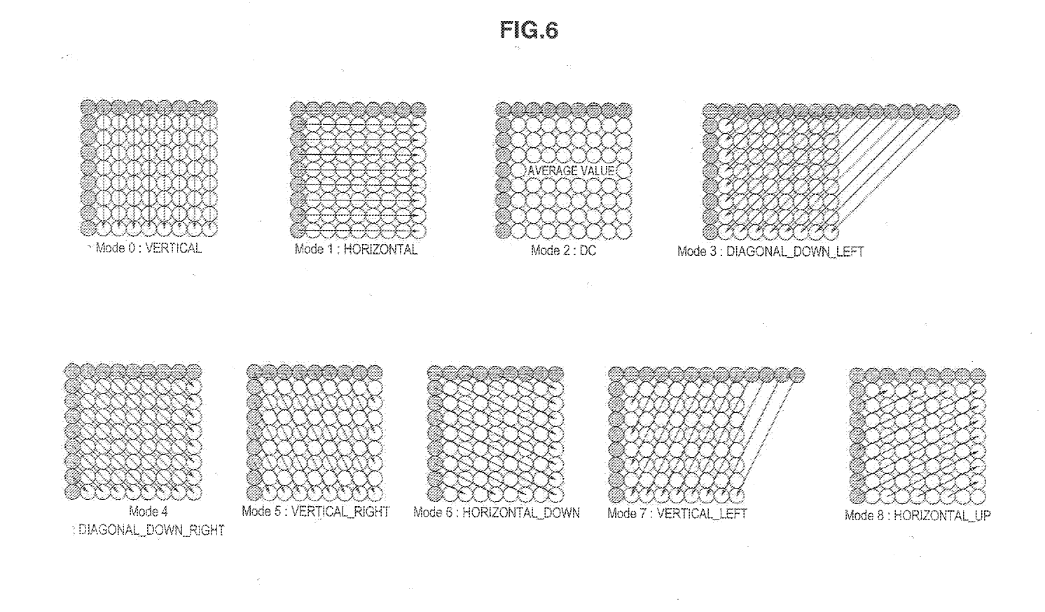

FIG. 6 is an explanatory diagram for describing candidates of a prediction mode in an intra 8×8 prediction mode. Referring to FIG. 6, nine types of prediction modes (Mode 0 to Mode 8) that may be used in the intra 8×8 prediction mode are shown.

The prediction direction in Mode 0 is a vertical direction. The prediction direction in Mode 1 is a horizontal direction. Mode 2 indicates DC prediction (average value prediction). The prediction direction in Mode 3 is diagonal down left. The prediction direction in Mode 4 is diagonal down right. The prediction direction in Mode 5 is vertical right. The prediction direction in Mode 6 is horizontal down. The prediction mode in Mode 7 is vertical left. The prediction direction in Mode 8 is horizontal up.

In the intra 8×8 prediction mode, before calculating the predicted pixel values, low-pass filtering is performed on the reference pixel values. Then, the predicted pixel values are calculated according to each prediction mode based on the reference pixel values after low-pass filtering. The calculation formulae of predicted pixel values in the nine types of prediction modes of the intra 8×8 prediction mode may also be the same as the calculation formulae defined by H.264/AVC. The first prediction calculation sections 43a of the first prediction section 42a and the second prediction calculation sections 43b of the second prediction section 42b in the intra prediction section 40 described above may calculate predicted pixel values corresponding to respective prediction modes based on the reference pixel values sorted by the sorting section 41 while taking the nine prediction modes of the intra 8×8 prediction mode as the candidates.

### (3) Intra 16×16 Prediction Mode

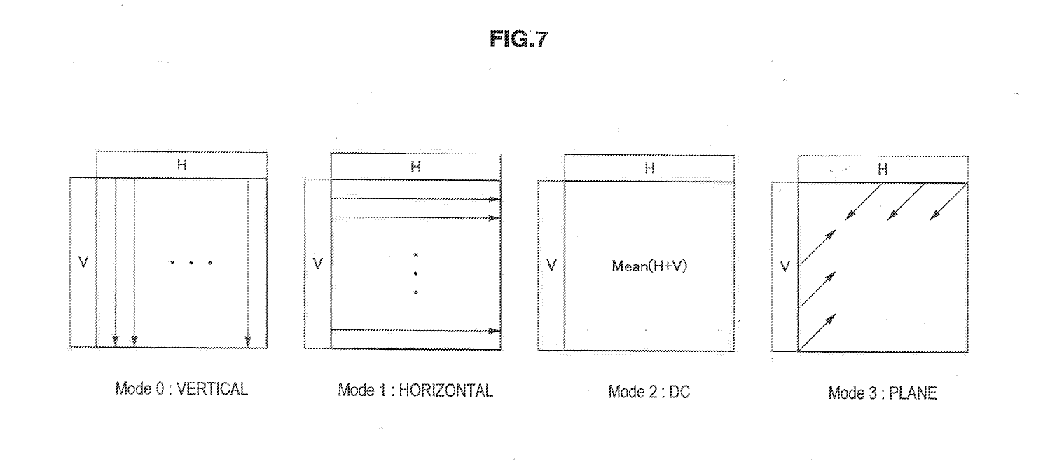

FIG. 7 is an explanatory diagram for describing candidates of a prediction mode in an intra 16×16 prediction mode. Referring to FIG. 7, four types of prediction modes (Mode 0 to Mode 3) that may be used in the intra 16×16 prediction mode are shown.

The prediction direction in Mode 0 is a vertical direction. The prediction direction in Mode 1 is a horizontal direction. Mode 2 indicates DC prediction 26 (average value prediction). Mode 3 indicates plane direction. The calculation formulae of predicted pixel values in the four types of prediction modes of the intra 16×16 prediction mode may also be the same as the calculation formulae defined by H.264/AVC. The first prediction calculation sections 43a of the first prediction section 42a and the second prediction calculation sections 43b of the second prediction section 42b in the intra prediction section 40 described above may calculate predicted pixel values corresponding to respective prediction modes based on the reference pixel values sorted by the sorting section 41 while taking the four prediction modes of the intra 16×16 prediction mode as the candidates.

### (4) Intra Prediction of Chroma Signal

A prediction mode for a chroma signal may be set independently of a prediction mode for a luma signal. The prediction mode for a chroma signal may include four types of prediction modes, as in the intra 16×16 prediction mode for a luma signal described above. In H.264/AVC, Mode 0 of the prediction mode for a chroma signal is DC prediction, Mode 1 is horizontal prediction, Mode 2 is vertical prediction, and Mode 4 is plane prediction.

[1-4. Explanation on Sorting Process]

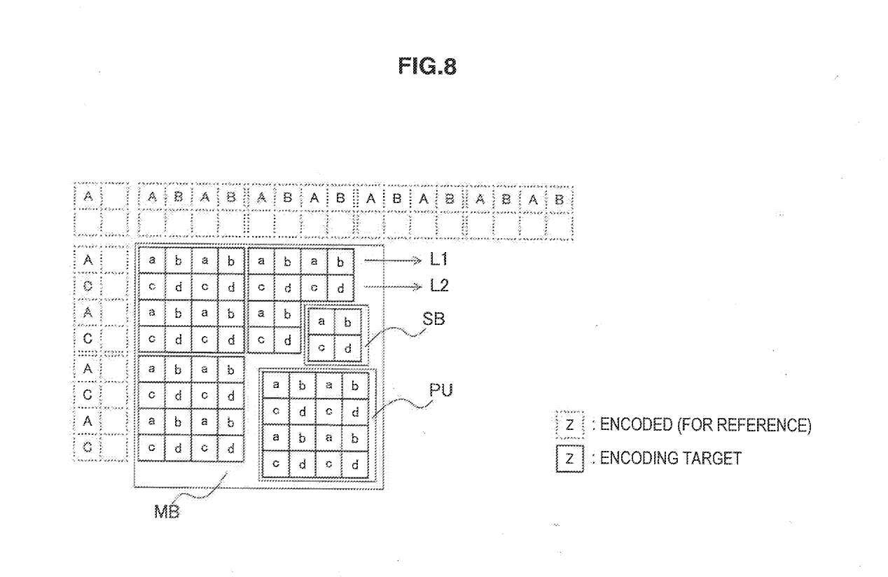

Next, a sorting process by the sorting section 41 of the intra prediction section 40 shown in FIG. 2 will be described using FIGS. 8 to 10.

FIG. 8 shows encoding target pixels in a macro block before sorting by the sorting section 41 of the intra prediction section 40 and reference pixels around the macro block.

Referring to FIG. 8, a macro block MB of 8×8 pixels includes four prediction units PU, each of 4×4 pixels. Also, one prediction unit PU includes four sub-blocks SB, each of 2×2 pixels. In the present specification, a sub-block is a collection of pixels smaller than the macro block. A pixel position is defined based on the sub-blocks. Pixels in one sub-block may be distinguished from one another by unique pixel positions. On the other hand, a plurality of different sub-blocks includes pixels at pixel positions that are mutually common. Additionally, a block corresponding to the macro block illustrated in FIG. 8 may also be referred to by terms “coding unit (CU)” and “largest coding unit (LCU)”.

In the example of FIG. 8, one sub-block SB includes four pixels (four types of pixel positions) represented respectively by lower case alphabets a to d. A first line L1 of the macro block MB includes four sub-blocks with a total of eight pixels a's and b's. The order of the pixels of the first line L1 is a, b, a, b, a, b, a, b. A second line L2 of the macro block MB includes four sub-blocks with a total of eight pixels c's and d's. The order of the pixels of the second line L2 is c, d, c, d, c, d, c, d. The order of pixels included in a third line of the macro block MB is the same as that of the first line L1. The order of pixels included in a fourth line of the macro block MB is the same as that of the second line L2.

Reference pixels represented respectively by upper case alphabets A, B and C are shown around the macro block MB. As can be seen from FIG. 8, in the present embodiment, pixels two lines above in the macro block MB, not the immediate above pixels in the macro block MB are used as the reference pixels. Also, pixels of the second column to the left in the macro block MB, not the pixels immediately on the left in the macro block MB, are used as the reference pixels.

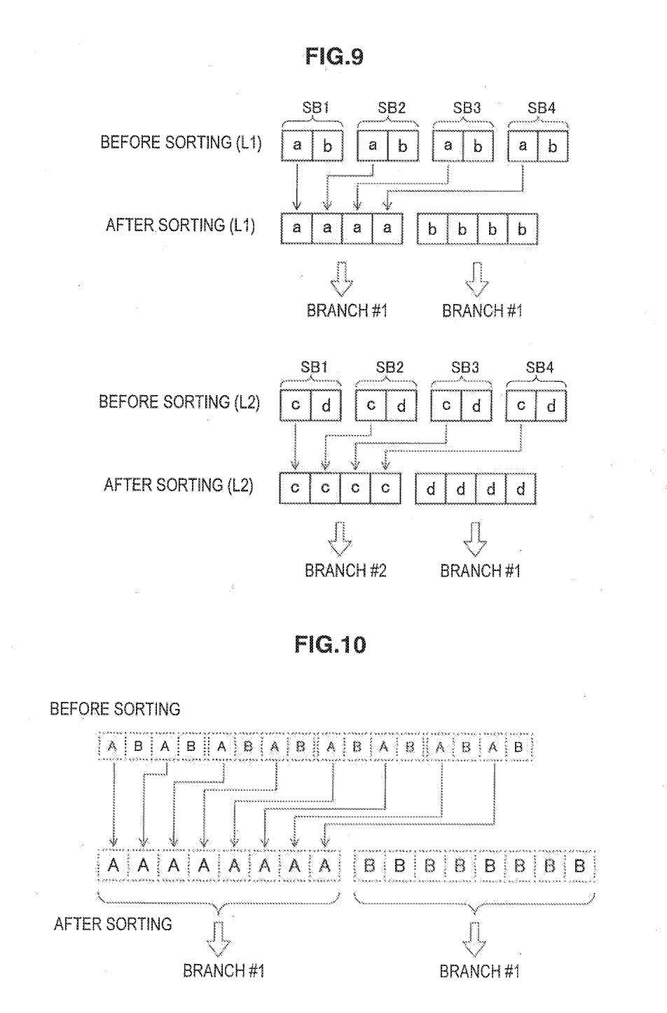

FIG. 9 is an explanatory diagram for describing an example of sorting of the encoding target pixels shown in FIG. 8 by the sorting section 41.

The rule of sorting of the pixel values by the sorting section 41 is a rule as follows, for example. That is, the sorting section 41 causes the pixel values, at common pixel positions, of adjacent sub-blocks included in the macro block MB to be adjacent to one another after the sorting. For example, in the example of FIG. 9, the pixel values of pixels a of sub-blocks SB1, SB2, SB3 and SB4 included in the first line L1 are adjacent to one another in this order after the sorting. The pixel values of pixels b of the sub-blocks SB1, SB2, SB3 and SB4 included in the first line L1 are also adjacent to one another in this order after the sorting. Likewise, the pixel values of pixels c of sub-blocks SB1, SB2, SB3 and SB4 included in the second line L2 are adjacent to one another in this order after the sorting. The pixel values of pixels d of the sub-blocks SB1, SB2, SB3 and SB4 included in the second line L2 are also adjacent to one another in this order after the sorting.

The sorting section 41 outputs the pixel values of the sorted pixels a of the sub-blocks SB1 to SB4 to the first prediction section 42a. Then, when generation of predicted pixel values of these pixels a is complete, the sorting section 41 outputs the pixel values of the sorted pixels b of the sub-blocks SB1 to SB4 to the first prediction section 42a. Subsequently, the sorting section 41 outputs the pixel values of the sorted pixels c of the sub-blocks SB1 to SB4 to the second prediction section 42b. Then, when generation of predicted pixel values of these pixel b and c is complete, the sorting section 41 outputs the pixel values of the sorted pixels d of the sub-blocks SB1 to SB4 to the first prediction section 42a.

FIG. 10 is an explanatory diagram for describing an example of sorting of the reference pixels shown in FIG. 8 by the sorting section 41.

The sorting section 41 causes the pixel values of reference pixels corresponding respectively to common pixel positions in adjacent sub-blocks SB included in the macro block MB to be adjacent to one another after the sorting. For example, in the example of FIG. 9, reference pixels A above the pixels a of the sub-blocks SB1, SB2, SB3 and SB4 are adjacent to one another in this order. The sorting section 41 outputs the pixel values of these reference pixels A to the first prediction section 42a. Then, when generation of predicted pixel values of the pixels a is complete, the sorting section 41 outputs the pixel values of reference pixels B to the first prediction section 42a. Additionally, in the example of FIG. 9, the pixel values of the pixels b may be output to the second prediction section 42b, and the pixel values of the pixels c may be output to the first prediction section 42a. In this case, the sorting section 41 outputs the pixel values of the reference pixels B to the second prediction section 42b.

The sorting section 41 outputs, without sorting, the pixel values of reference pixels A and C on the left of the macro block MB to the first prediction section 42a and the second prediction section 42b.

[1-5. First Example of Parallel Processing]

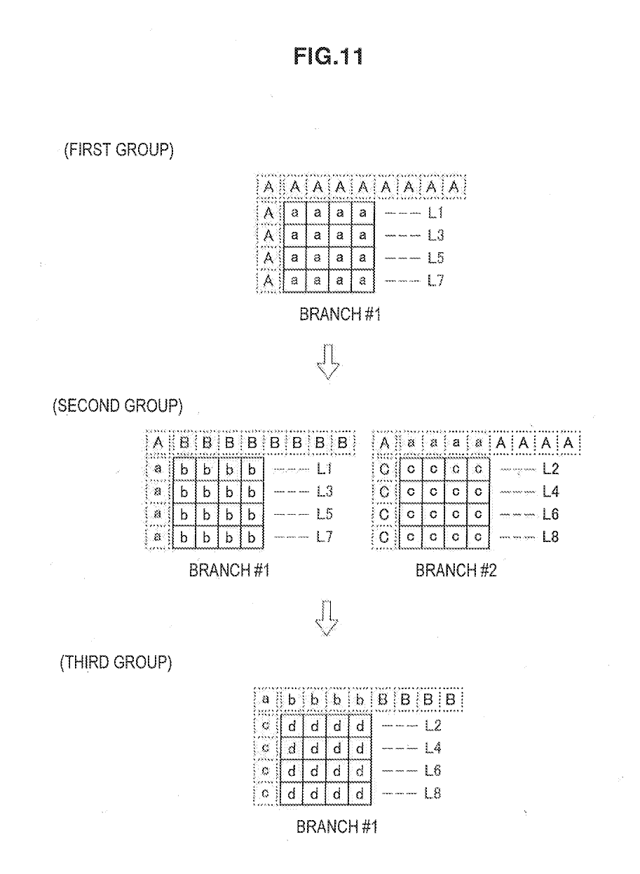

FIG. 11 is an explanatory diagram for describing an example of parallel processing by the first prediction section 42a and the second prediction section 42b of the intra prediction section 40. Referring to FIG. 11, the generation process of predicted pixel values for the pixels in the macro block MB shown in FIG. 8 is divided into first, second and third groups.

The first group includes only the generation of predicted pixel values of the pixels a by the first prediction section 42a. That is, the generation of predicted pixel values of the pixels a belonging to the first group is not performed in parallel with the generation of predicted pixel values of other pixel positions. The first prediction section 42a uses pixels A as the reference pixels above, on the top right, on the top left and on the left.

The second group includes the generation of predicted pixel values of the pixels b by the first prediction section 42a, and the generation of predicted pixel values of the pixels c by the second prediction section 42b. That is, the generation of predicted pixel values of the pixels b and the generation of predicted pixel values of the pixels c are performed in parallel. The first prediction section 42a uses pixels B as the reference pixels above and on the top right, a pixel A as the reference pixel on the top left, and the pixels a for which the predicted pixel values have been generated in the first group as the reference pixels on the left. The second prediction section 42b uses the pixels a for which the predicted pixel values have been generated in the first group as the reference pixels above, pixels A as the reference pixels on the top right and the top left, and pixels C as the reference pixels on the left. Additionally, instead of the example of FIG. 11, the first prediction section 42a may generate the predicted pixel value of the pixel c, and the second prediction section 42b may generate the predicted pixel value of the pixel b.

The third group includes only the generation of predicted pixel values of the pixels d by the first prediction section 42a. That is, the generation of predicted pixel values of the pixels d belonging to the third group is not performed in parallel with the generation of predicted pixel values of other pixel positions. The first prediction section 42a uses the pixels b for which predicted pixel values have been generated in the second group as the reference pixels above, pixels B as the reference pixels on the top right, the pixel a for which the predicted pixel value has been generated in the first group as the reference pixel on the top left, and the pixels c for which the predicted pixel values have been generated in the second group as the reference pixels on the left.

Generation of predicted pixel values may be performed with respect to the four types of pixel positions of each sub-block with less time by the parallel processing above than when serially generating the predicted pixel values. Also, the predicted pixel values of the pixels a belonging to the first group shown in FIG. 11 are generated using only the correlation between the pixels a and the correlation with the reference pixels A corresponding to the pixels a, without using the correlation with the pixel values of other pixel positions. Thus, by encoding an image by such an intra prediction process, a terminal with low processing performance or a low-resolution display is enabled to partially decode only the pixel values of the positions of the pixels a, for example.

[1-6. Second Example of Parallel Processing]

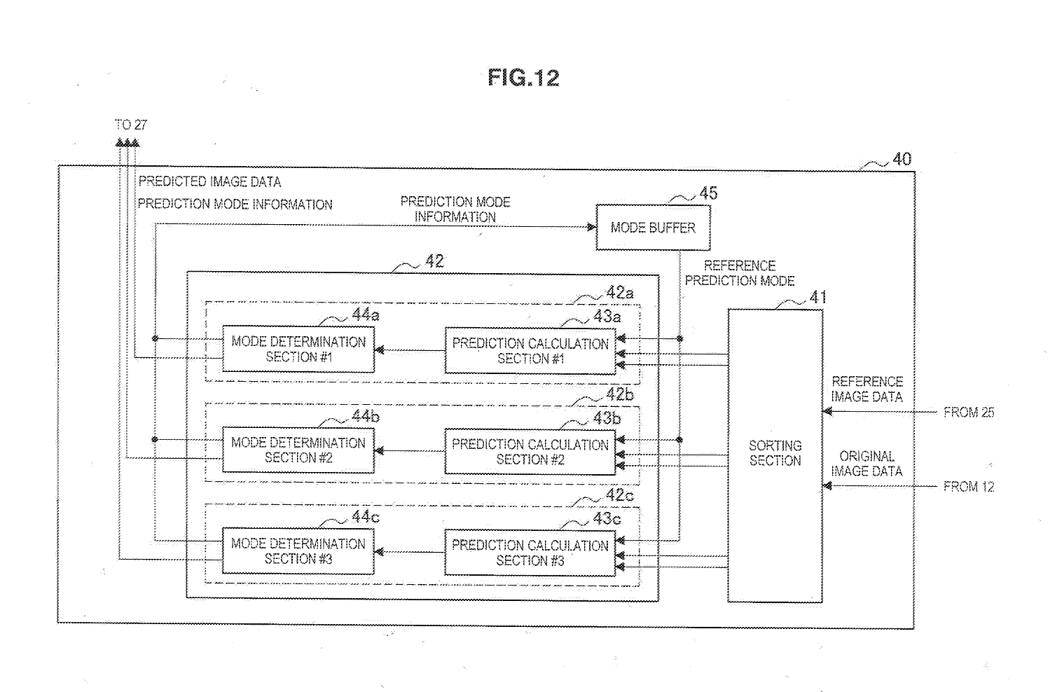

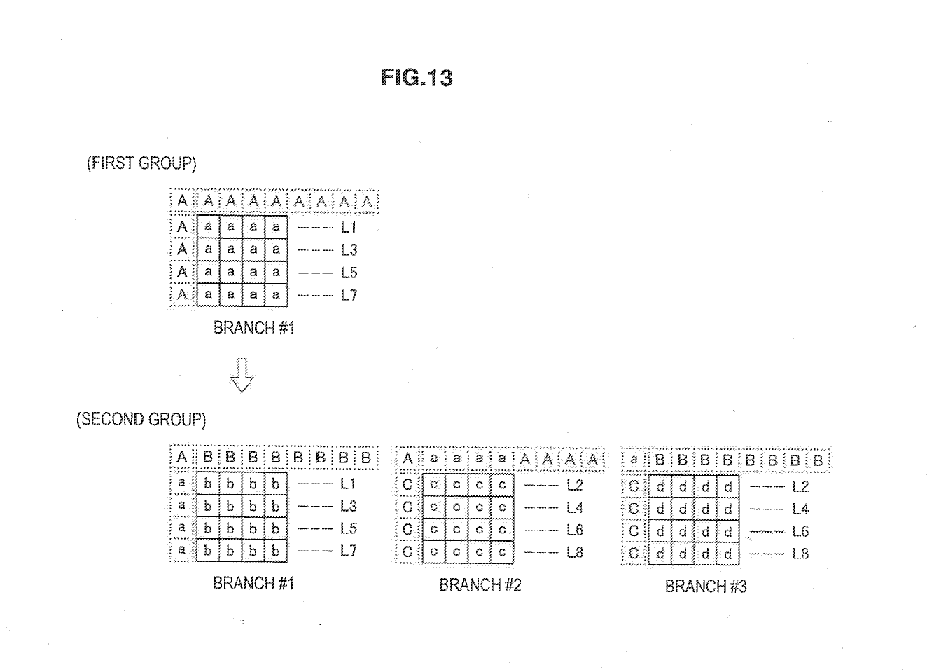

Additionally, the intra prediction section 40 may realize parallel processing different from the example of FIG. 11 by including a third prediction section (a third processing branch). FIG. 12 is a block diagram showing an example of a detailed configuration of such an intra prediction section 40. Referring to FIG. 12, the intra prediction section 40 includes the sorting section 41, the prediction section 42 and the mode buffer 45. Also, the prediction section 42 includes three processing branches, the first prediction section 42a, the second prediction section 42b and a third prediction section 42c, that are arranged in parallel.

FIG. 13 is an explanatory diagram for describing an example of the parallel processing by the intra prediction section 40 shown in FIG. 12. Referring to FIG. 13, the generation process of predicted pixel values for the pixels in the macro block MB shown in FIG. 8 is divided into first and second groups.

The first group includes only the generation of predicted pixel values of the pixels a by the first prediction section 42a. That is, the generation of predicted pixel values of the pixels a belonging to the first group is not performed in parallel with the generation of predicted pixel values of other pixel positions. The first prediction section 42a uses pixels A as the reference pixels above, on the top right, on the top left and on the left.

The second group includes the generation of predicted pixel values of the pixels b by the first prediction section 42a, the generation of predicted pixel values of the pixels c by the second prediction section 42b, and the generation of predicted pixel values of the pixels d by the third prediction section 42c. That is, the generation of predicted pixel values of the pixels b, the pixels c and the pixels d are performed in parallel. The first prediction section 42a uses pixels B as the reference pixels above and on the top right, a pixel A as the reference pixel on the top left, and the pixels a for which the predicted pixel values have been generated in the first group as the reference pixels on the left. The second prediction section 42b uses the pixels a for which the predicted pixel values have been generated in the first group as the reference pixels above, pixels A as the reference pixels on the top right and the top left, and pixels C as the reference pixels on the left. The third prediction section 42d uses pixels B as the reference pixels above and on the top right, the pixel a for which the predicted pixel value has been generated in the first group as the reference pixel on the top left, and pixels C as the reference pixels on the left.

Generation of predicted pixel values may be performed with respect to each block with less time by the parallel processing above than the parallel processing of the first example. Also, as with the first example, the predicted pixel values of the pixels a belonging to the first group shown in FIG. 13 are generated using only the correlation between the pixels a and the correlation with the reference pixels A corresponding to the pixels a, without using the correlation with the pixel values of other pixel positions. Thus, by encoding an image by such an intra prediction process, a terminal with low processing performance or a low-resolution display is enabled to partially decode only the pixel values of the positions of the pixels a, for example.

Additionally, in FIGS. 11 and 13, examples of performing the intra prediction process in the intra 4×4 prediction mode have been mainly described. However, the intra prediction section 40 may also perform the intra prediction process in the intra 8×8 prediction mode or the intra 16×16 prediction mode described above.

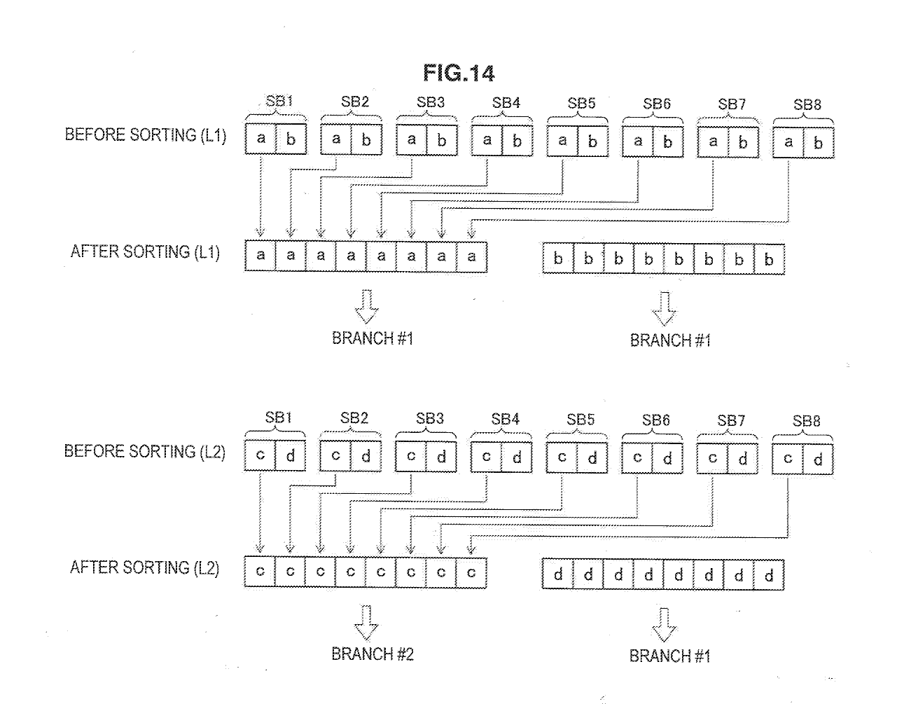

For example, referring to FIG. 14, the pixel values of pixels a of eight sub-blocks SB1 to SB8 included in the first line L1 are adjacent to one another after the sorting. The pixel values of pixels b of the eight sub-blocks SB1 to SB8 included in the first line L1 are also adjacent to one another after the sorting. The same can be said for the pixel values of pixels c and pixels d included in the second line L2. Among these, the pixel values of the sorted pixels a are output to the first prediction section 42a. The first prediction section 42a can thereby generate the predicted pixel values of the pixels a in the intra 8×8 prediction mode. In the same manner, the predicted pixel values of the pixels b, c and d may be generated in the intra 8×8 prediction mode.

[1-7. Explanation on New Prediction Mode]

As described in relation to FIG. 3, with the existing intra prediction scheme, nine types of prediction modes (Mode 0 to Mode 8) may be used in the intra 4×4 prediction mode. In addition to this, in the present embodiment, a new prediction mode based on a correlation between adjacent pixels in a macro block may be used as a candidate of prediction mode. In the present specification, this new prediction mode is Mode 9. Mode 9 is a mode of generating a pixel value of a prediction target by phase-shifting the pixel values around the prediction target pixel based on a neighborhood correlation between adjacent pixels.

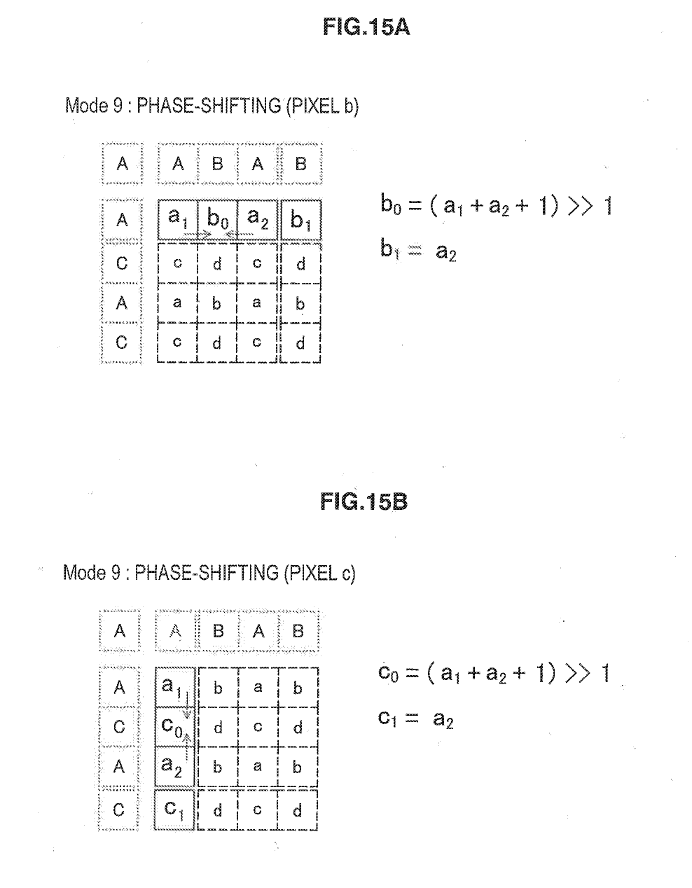

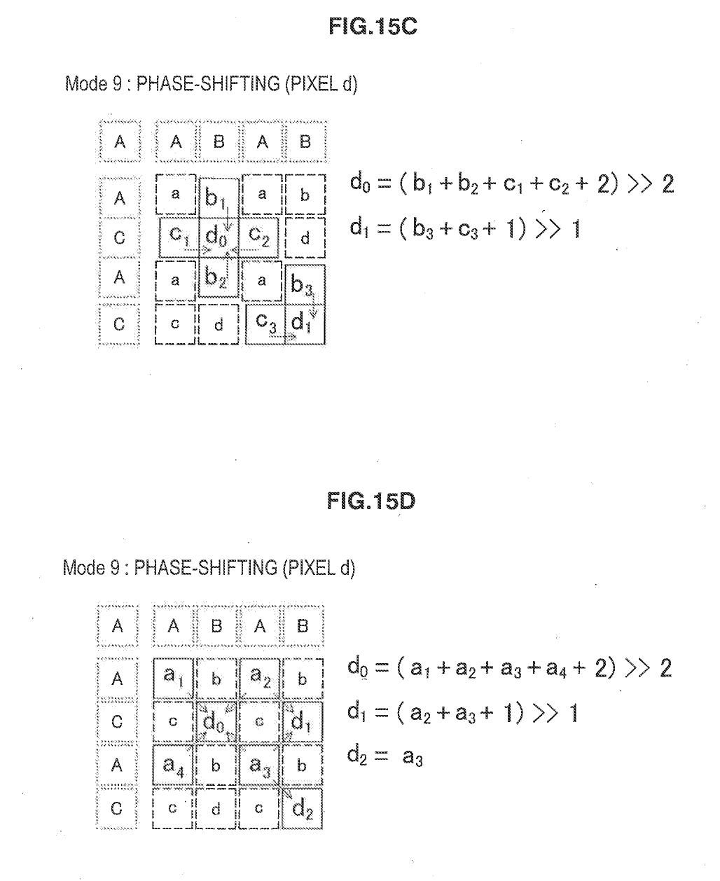

FIGS. 15A to 15D are explanatory diagrams for describing Mode 9, which is the new prediction mode. Referring to FIG. 15A, prediction formulae of Mode 9 for the pixel b in a sub-block illustrated in FIG. 8 are shown. When a pixel which is a prediction target is given as b₀, and the left pixel and the right pixel of the pixel be before sorting are given as pixels a₁ and a₂, respectively, the predicted pixel value of the pixel b₀ may be calculated in the following manner:

b₀=(a₁+a₂+1)>>1

Also, with respect to a pixel b₁, for example, since it is at the right end of the prediction unit, there is no pixel on its right. In this case, the predicted pixel value of the pixel b₁ may be calculated in the following manner:

b₁=a₂

These prediction formulae are possible because the pixel a is already encoded before the pixel b.

The prediction formulae shown in FIG. 15A are prediction formulae for phase-shifting a pixel value by so-called linear interpolation computation. Alternatively, a prediction formula for phase-shifting pixel values by calculation of a finite impulse response (FIR) filter using the pixel values of a plurality of pixels a on the left of the pixel b and the pixel values of a plurality of pixels a on the right of the pixel b may be used. The number of taps of the FIR filter in this case may be six, four or the like, for example.

Referring to FIG. 15B, prediction formulae of Mode 9 for the pixel c in a sub-block illustrated in FIG. 8 are shown. When a pixel which is a prediction target is given as c₀, and the pixel above and the pixel below the pixel c₀ before sorting are given as pixels a₁ and a₂, respectively, the predicted pixel value of the pixel c₀ may be calculated in the following manner:

c₀=(a₁+a₂+1)>>1

Also, with respect to a pixel c₁, for example, since it is at the lower end of the prediction unit, there is no pixel below. In this case, the predicted pixel value of the pixel c₁ may be calculated in the following manner:

c₁=a₂

These prediction formulae are possible because the pixel a is already encoded before the pixel c. Of course, a prediction formula based on the calculation of the FIR filter may be used also for the pixel c, instead of the linear interpolation.

Referring to FIG. 5C, prediction formulae of Mode 9 for the pixel d in a sub-block illustrated in FIG. 8 are shown. When a pixel which is a prediction target is given as d₀, the pixel on the left and the pixel on the right are given as pixels c₁ and c₂, respectively, and the pixel above and the pixel below the pixel d₀ are given as pixels b₁ and b₂, respectively, the predicted pixel value of the pixel d₀ may be calculated in the following manner:

d₀=(b₁+b₂+c₁+c₂+2)>>2

Also, with respect to a pixel d₁, for example, since it is at the lower right corner of the prediction unit, there is no pixel on the right or below. In this case, the predicted pixel value of the pixel d₁ may be calculated in the following manner:

d₁=(b₃+c₃+1)>>1

These prediction formulae are possible because the pixels b and c are already encoded before the pixel d.

Additionally, the prediction formulae of Mode 9 for the pixel d shown in FIG. 15C assume that, as with the parallel processing described in relation to FIG. 11, the generation of predicted pixel values of the adjacent pixels b and c is complete at the time of performing prediction for the pixel d. In contrast, in the case the generation of predicted pixel values of the pixels b and c is not complete at the time of performing prediction for the pixel d, as with the parallel processing described in relation to FIG. 13, prediction formulae shown in FIG. 15D may be used.

Referring to FIG. 15D, other examples of the prediction formulae of Mode 9 for the pixel d are shown. When a pixel which is a prediction target is given as d₀, and the pixels on the top left, top right, lower right and lower left of the pixel d₀ are given as pixels a₁, a₂, a₃ and a₄, respectively, the predicted pixel value of the pixel d₀ may be calculated in the following manner:

d₀=(a₁+a₂+a₃+a₄+2)>>2

Also, with respect to a pixel d₁, for example, since it is at the right end of the prediction unit, there is not pixel on the top right or lower right. In this case, the predicted pixel value of the d₁ may be calculated in the following manner:

d₁=(a₂+a₃+1)>>1

Furthermore, with respect to a pixel d₂, for example, since it is at the lower right corner of the prediction unit, there is no pixel on the top right, lower right or lower left. In this case, the predicted pixel value of the pixel d₂ may be calculated in the following manner:

d₂=a₃

These prediction formulae are possible because the pixel a is already encoded before the pixel d.

As described, by including a new prediction mode that is based on the correlation between pixels in a prediction unit in the candidates of prediction mode, the accuracy of the intra prediction can be increased, and the coding efficiency can be increased compared to the existing scheme. Now, the correlation between pixels is generally stronger as the distance between the pixels is less. Thus, the new prediction mode described above that generates a predicted pixel value from the pixel values of an adjacent pixel in the macro block can be said to be an effective prediction mode for increasing the accuracy of the intra prediction and increasing the coding efficiency.

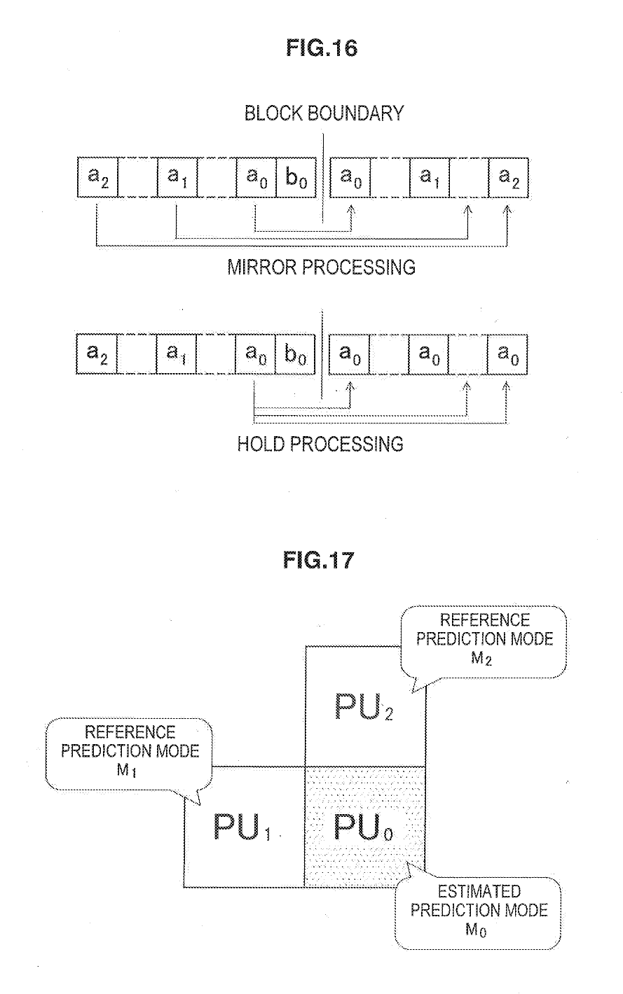

Additionally, in the case a pixel which is a prediction target is positioned at an end portion of a prediction unit, a prediction formula according to the linear interpolation or the calculation of the FIR filter may be applied after inserting a pixel value outside the boundary by performing mirror processing of a pixel value across the boundary of the prediction unit. Also, the pixel value outside the boundary may be inserted by hold processing. For example, in the upper example of FIG. 16, the mirror processing is performed on the pixel values of three pixels a₀, a₁ and a₂ on the left of the pixel b₀ at the right end of the prediction unit so as to obtain pixel values outside the boundary of the prediction unit. Also, in the lower example of FIG. 16, pixel values outside the boundary of the prediction unit are inserted by the hold processing on the pixel value of the pixel a₀ on the left of the pixel b₀ at the right end of the prediction unit. In either case, as a result of inserting the pixel values, the pixel values of six pixels aᵢ near the pixel b₀ are enabled to be used. The predicted pixel value of the pixel b₀ can thereby be generated using a 6-tap FIR filter, for example.

Incidentally, the advantages described above regarding the increase in the processing speed by the parallel intra prediction and the increase in the coding efficiency by the new prediction mode may be achieved without presupposing partial decoding, through the sorting of pixel values illustrated in FIGS. 9 and 10. In the case the partial coding is not presupposed, a pixel immediately above or immediately on the left of the macro block MB may be used as the reference pixel, instead of a pixel separated from the macro block MB by one line or one column, as shown in FIG. 8.

[1-8. Estimation of Prediction Direction]

The first prediction section 42a and the second prediction section 42b (and the third prediction section 42c) of the intra prediction section 40 may estimate an optimal prediction mode (prediction direction) of an encoding target block from the prediction mode (prediction direction) set for a block to which a reference pixel belongs, to suppress the increase in the bit rate due to the encoding of prediction mode information. In this case, if a prediction mode that is estimated (hereinafter, referred to as an estimated prediction mode) and an optimal prediction mode selected using a cost function are the same, only the information indicating that the prediction mode can be estimated may be encoded as the prediction mode information. The information indicating that the prediction mode can be estimated corresponds to “MostProbableMode” in H.264/AVC, for example.

FIG. 17 is an explanatory diagram for describing estimation of a prediction direction. Referring to FIG. 17, a prediction unit PU₀ which is an encoding target, and a reference block PU₁ on the left of the prediction unit PU₀ and a reference block PU₂ above the prediction unit PU₀ are shown. A reference prediction mode set for the reference block PU₁ is M₁, and a reference prediction mode set for the reference block PU₂ is M₂. Also, the estimated prediction mode for the encoding target prediction unit PU₀ is M₀.

In H.264/AVC, the estimated prediction mode M₀ is decided by the following formula:

M₀=min(M₁,M₂)

That is, one with a smaller prediction mode number, of the reference prediction modes M₁ and M₂, will be the estimated prediction mode for the encoding target prediction unit.

The first prediction section 42a of the intra prediction section 40 according to the present embodiment decides such an estimated prediction mode for each group obtained after the sorting as shown in FIG. 11 or 13. For example, the estimated prediction mode for the first group (that is, the pixel a) is decided based on the reference prediction modes of the reference block above and the reference block on the right of the pixel a after the sorting. Then, in the case the estimated prediction mode decided for the pixel a and the optimal prediction mode are the same (that is, in the case the prediction mode can be estimated), the first prediction section 42a generates information indicating that a prediction mode can be estimated for the pixel a, instead of a prediction mode number, and outputs the generated information.

By deciding the estimated prediction mode for the pixel a based only on the prediction mode for the pixel a in a reference block in this manner, the increase in the bit rate can be suppressed by using the estimated prediction mode also in the case of realizing partial decoding of only the pixel a.

### 2. Flow of Process at the Time of Encoding According to an Embodiment

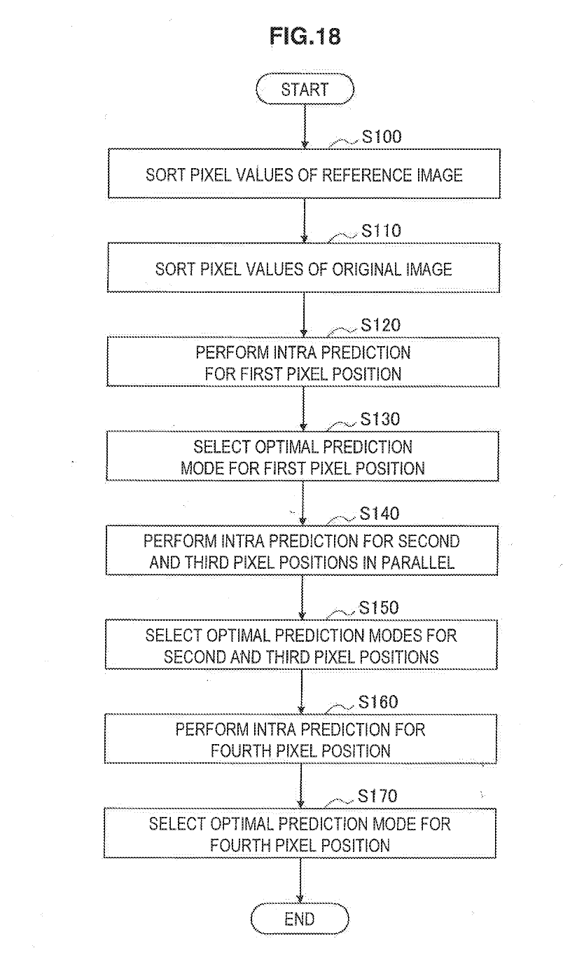

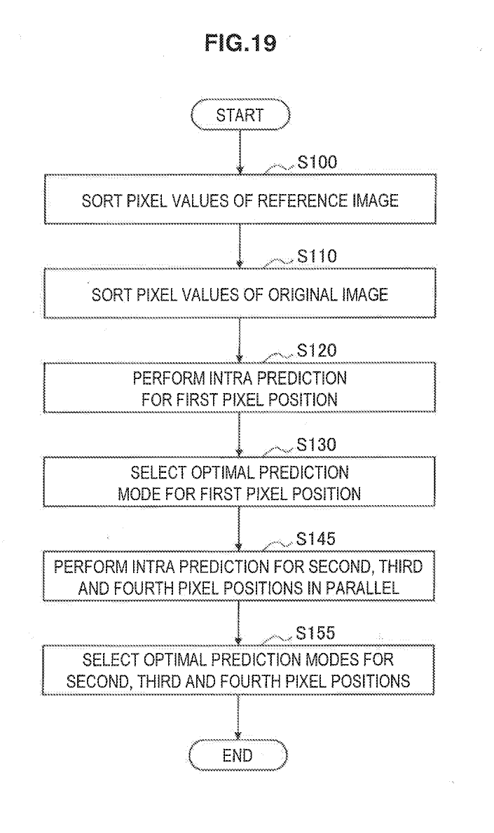

Next, a flow of process at the time of encoding will be described using FIGS. 18 and 19. FIG. 18 is a flow chart showing an example of a flow of the intra prediction process at the time of encoding of the intra prediction section 40 having the configuration illustrated in FIG. 2.

Referring to FIG. 18, first, the sorting section 41 sorts the reference pixel values included in reference image data supplied from the frame memory 25 according to the rule illustrated in FIG. 10 (step S100). Then, the sorting section 41 outputs the reference pixel value for a first pixel position (for example, a pixel a), among the series of sorted reference pixel values, to the first prediction section 42a.

Next, the sorting section 41 sorts the pixel values included in a macro block in the original image according to the rule illustrated in FIG. 9 (step S110). Then, the sorting section 41 outputs the pixel value of the first pixel position, of the series of sorted pixel values, to the first prediction section 42a.

Next, the first prediction section 42a performs the intra prediction process for the pixel of the first pixel position without using the correlation with the pixel value of another pixel position (step S120). Then, the first prediction section 42a selects an optimal prediction mode from a plurality of prediction modes (step S130). Prediction mode information indicating the optimal prediction mode selected here (or information indicating that estimation of a prediction mode is possible) is output from the intra prediction section 40 to the lossless encoding section 16. Also, predicted pixel data including the predicted pixel value corresponding to the optimal prediction mode is output from the intra prediction section 40 to the subtraction section 13.

Next, the sorting section 41 outputs the reference pixel value for a second pixel position (for example, a pixel b) and the pixel value of the second pixel position to the first prediction section 42a. Also, the sorting section 41 outputs the reference pixel value for a third pixel position (for example, a pixel c) and the pixel value of the third pixel position to the second prediction section 42b. Then, the intra prediction process by the first prediction section 42a for the pixel of the second pixel position and the intra prediction process by the second prediction section 42b for the pixel of the third pixel position are performed in parallel (step S140). Then, the first prediction section 42a and the second prediction section 42b each select an optimal prediction mode from a plurality of prediction modes (step S150). Additionally, the plurality of prediction modes here includes the new prediction mode described above that is based on the correlation with the pixel value of the first pixel position. Prediction mode information indicating the optimal prediction mode selected here is output from the intra prediction section 40 to the lossless encoding section 16. Also, predicted pixel data including the predicted pixel value corresponding to the optimal prediction mode is output from the intra prediction section 40 to the subtraction section 13.

Next, the sorting section 41 outputs the reference pixel value for a fourth pixel position (for example, a pixel d) and the pixel value of the fourth pixel position to the first prediction section 42a. Then, the first prediction section 42a performs the intra prediction process for the pixel of the fourth pixel position (step S160). Then, the first prediction section 42a selects an optimal prediction mode from a plurality of prediction modes (step S170). Additionally, the plurality of prediction modes here include the new prediction mode described above that is based on the correlation between the pixel values of the second pixel position and the third pixel position. Prediction mode information indicating the optimal prediction mode selected here is output from the intra prediction section 40 to the lossless encoding section 16. Also, predicted pixel data including the predicted pixel value corresponding to the optimal prediction mode is output from the intra prediction section 40 to the subtraction section 13.

FIG. 19 is a flow chart showing an example of a flow of the intra prediction process at the time of encoding of the intra prediction section 40 having the configuration illustrated in FIG. 12.

Referring to FIG. 19, first, the sorting section 41 sorts the reference pixel values included in reference image data supplied from the frame memory 25 according to the rule illustrated in FIG. 10 (step S100). Then, the sorting section 41 outputs the reference pixel value for a first pixel position (for example, a pixel a), among the series of sorted reference pixel values, to the first prediction section 42a.

Next, the sorting section 41 sorts the pixel values included in a macro block in the original image according to the rule illustrated in FIG. 9 (step S110). Then, the sorting section 41 outputs the pixel value of the first pixel position, of the series of sorted pixel values, to the first prediction section 42a.

Next, the first prediction section 42a performs the intra prediction process for the pixel of the first pixel position without using the correlation with the pixel value of another pixel position (step S120). Then, the first prediction section 42a selects an optimal prediction mode from a plurality of prediction modes (step S130). Prediction mode information indicating the optimal prediction mode selected here (or information indicating that estimation of a prediction mode is possible) is output from the intra prediction section 40 to the lossless encoding section 16. Also, predicted pixel data including the predicted pixel value is output from the intra prediction section 40 to the subtraction section 13.

Next, the sorting section 41 outputs the reference pixel value for a second pixel position (for example, a pixel b) and the pixel value of the second pixel position to the first prediction section 42a. Also, the sorting section 41 outputs the reference pixel value for a third pixel position (for example, a pixel c) and the pixel value of the third pixel position to the second prediction section 42b. Furthermore, the sorting section 41 outputs the reference pixel value for a fourth pixel position (for example, a pixel d) and the pixel value of the fourth pixel position to the third prediction section 42c. Then, the intra prediction process by the first prediction section 42a for the pixel of the second pixel position, the intra prediction process by the second prediction section 42b for the pixel of the third pixel position, and the intra prediction process by the third prediction section 42c for the pixel of the fourth pixel position are performed in parallel (step S145). Then, the first prediction section 42a, the second prediction section 42b and the third prediction section 42c each select an optimal prediction mode from a plurality of prediction modes (step S155). Additionally, the plurality of prediction modes here may include the new prediction mode described above that is based on the correlation with the pixel value of the first pixel position. Prediction mode information indicating the optimal prediction mode selected here is output from the intra prediction section 40 to the lossless encoding section 16. Also, predicted pixel data including the predicted pixel value corresponding to the optimal prediction mode is output from the intra prediction section 40 to the subtraction section 13.

### 3. Example Configuration of Image Decoding Device According to an Embodiment

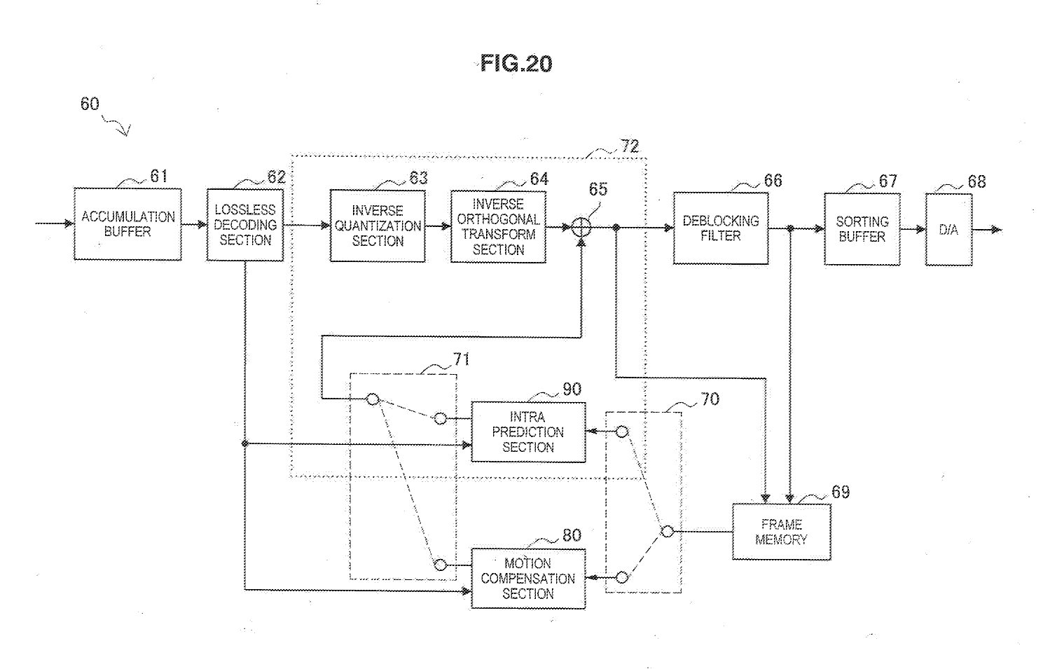

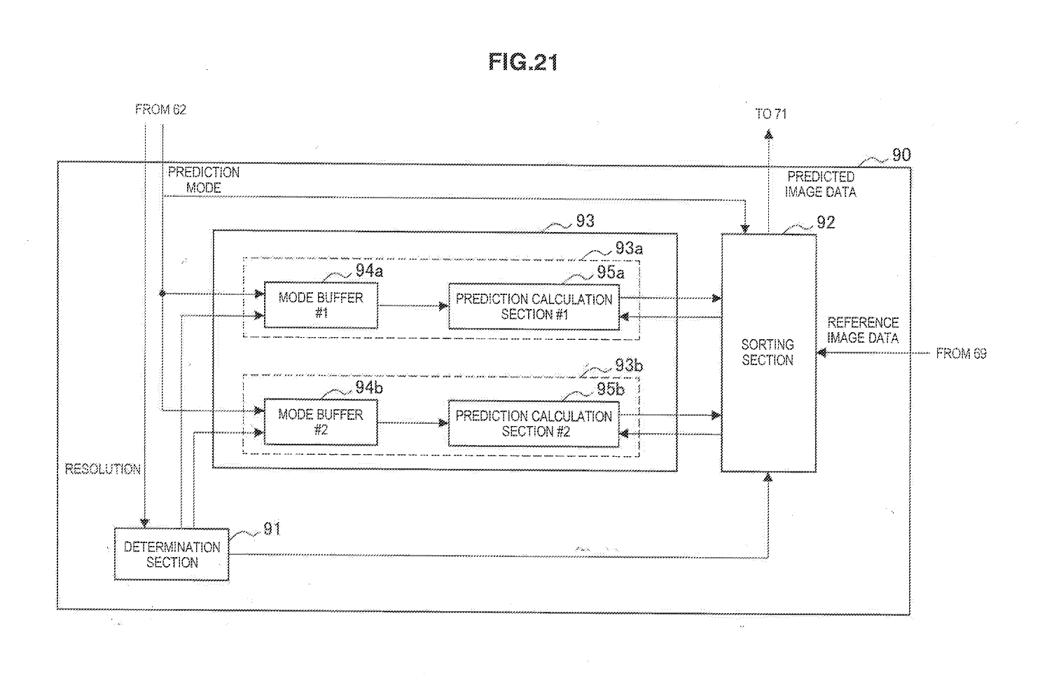

In this section, an example configuration of an image decoding device according to an embodiment will be described using FIGS. 20 and 21.

[3-1. Example of Overall Configuration]

FIG. 20 is a block diagram showing an example of a configuration of an image decoding device 60 according to an embodiment. Referring to FIG. 20, the image decoding device 60 includes an accumulation buffer 61, a lossless decoding section 62, an inverse quantization section 63, an inverse orthogonal transform section 64, an addition section 65, a deblocking filter 66, a sorting buffer 67, a D/A (Digital to Analogue) conversion section 68, a frame memory 69, selectors 70 and 71, a motion compensation section 80 and an intra prediction section 90.

The accumulation buffer 61 temporarily stores an encoded stream input via a transmission line using a storage medium.

The lossless decoding section 62 decodes an encoded stream input from the accumulation buffer 61 according to the encoding method used at the time of encoding. Also, the lossless decoding section 62 decodes information multiplexed to the header region of the encoded stream. Information that is multiplexed to the header region of the encoded stream may include information about inter prediction and information about intra prediction in the block header, for example. The lossless decoding section 62 outputs the information about inter prediction to the motion compensation section 80. Also, the lossless decoding section 62 outputs the information about intra prediction to the intra prediction section 90.

The inverse quantization section 63 inversely quantizes quantized data which has been decoded by the lossless decoding section 62. The inverse orthogonal transform section 64 generates predicted error data by performing inverse orthogonal transformation on transform coefficient data input from the inverse quantization section 63 according to the orthogonal transformation method used at the time of encoding. Then, the inverse orthogonal transform section 64 outputs the generated predicted error data to the addition section 65.

The addition section 65 adds the predicted error data input from the inverse orthogonal transform section 64 and predicted image data input from the selector 71 to thereby generate decoded image data. Then, the addition section 65 outputs the generated decoded image data to the deblocking filter 66 and the frame memory 69.

The deblocking filter 66 removes block distortion by filtering the decoded image data input from the addition section 65, and outputs the decoded image data after filtering to the sorting buffer 67 and the frame memory 69.

The sorting buffer 67 generates a series of image data in a time sequence by sorting images input from the deblocking filter 66. Then, the sorting buffer 67 outputs the generated image data to the D/A conversion section 68.

The D/A conversion section 68 converts the image data in a digital format input from the sorting buffer 67 into an image signal in an analogue format. Then, the D/A conversion section 68 causes an image to be displayed by outputting the analogue image signal to a display (not shown) connected to the image decoding device 60, for example.

The frame memory 69 stores, using a storage medium, the decoded image data before filtering input from the addition section 65, and the decoded image data after filtering input from the deblocking filter 66.

The selector 70 switches the output destination of the image data from the frame memory 70 between the motion compensation section 80 and the intra prediction section 90 for each block in the image according to mode information acquired by the lossless decoding section 62. For example, in the case the inter prediction mode is specified, the selector 70 outputs the decoded image data after filtering that is supplied from the frame memory 70 to the motion compensation section 80 as the reference image data. Also, in the case the intra prediction mode is specified, the selector 70 outputs the decoded image data before filtering that is supplied from the frame memory 70 to the intra prediction section 90 as reference image data.

The selector 71 switches the output source of predicted image data to be supplied to the addition section 65 between the motion compensation section 80 and the intra prediction section 90 according to the mode information acquired by the lossless decoding section 62. For example, in the case the inter prediction mode is specified, the selector 71 supplies to the addition section 65 the predicted image data output from the motion compensation section 80. Also, in the case the intra prediction mode is specified, the selector 71 supplies to the addition section 65 the predicted image data output from the intra prediction section 90.

The motion compensation section 80 performs a motion compensation process based on the information about inter prediction input from the lossless decoding section 62 and the reference image data from the frame memory 69, and generates predicted image data. Then, the motion compensation section 80 outputs the generated predicted image data to the selector 71.

The intra prediction section 90 performs an intra prediction process based on the information about intra prediction input from the lossless decoding section 62 and the reference image data from the frame memory 69, and generates predicted image data. Then, the intra prediction section 90 outputs the generated predicted image data to the selector 71. In the present embodiment, the intra prediction process of the intra prediction section 90 is parallelized by a plurality of processing branches. Parallel intra prediction processing by the intra prediction section 90 will be described later in detail.

Additionally, in a case image data of resolution that is too high to be supported by the processing performance or the display resolution of the image decoding device 60 is input, the intra prediction section 90, for example, performs the intra prediction process only for the first pixel position in each sub-block, and generates predicted image data of low resolution. In this case, the motion compensation section 80, too, may perform the inter prediction process only for the first pixel position and generate predicted image data of low resolution.

On the other hand, in the case the resolution of input image data can be supported, the intra prediction section 90 may perform the intra prediction process for all the pixel positions included in the macro block. At this time, the intra prediction section 90 performs a part of the intra prediction process in parallel using a plurality of processing branches.

With the parallelization of the intra prediction process of the intra prediction section 90, the processing, related to the intra prediction mode, of the inverse quantization section 63, the inverse orthogonal transform section 64 and the addition section 65 described above may also be parallelized. In this case, as shown in FIG. 20, the inverse quantization section 63, the inverse orthogonal transform section 64, the addition section 65 and the intra prediction section 90 form a parallel processing segment 72. Also, each section in the parallel processing segment 72 includes a plurality of processing branches. Each section in the parallel processing segment 72 may, while performing parallel processing in the intra prediction mode using a plurality of processing branches, use only one processing branch in the inter prediction mode.

[3-2. Example Configuration of Intra Prediction Section]

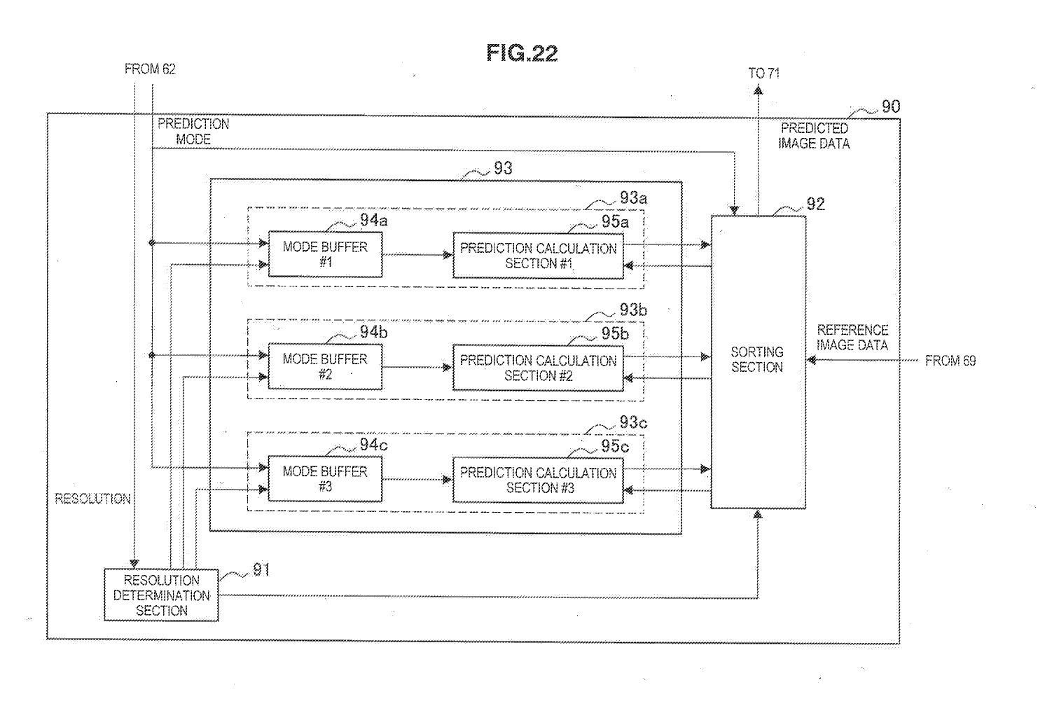

FIGS. 21 and 22 are each a block diagram showing an example of a detailed configuration of the intra prediction section 90 of the image decoding device 60 shown in FIG. 20.

### (1) First Example Configuration

FIG. 21 shows a first example configuration of a decoding side corresponding to the example configuration of the intra prediction section 40 on the encoding side illustrated in FIG. 2. Referring to FIG. 21, the intra prediction section 90 includes a determination section 91, a sorting section 92 and a prediction section 93. Also, the prediction section 93 includes a first prediction section 93a and a second prediction section 93b that are two processing branches arranged in parallel.

The determination section 91 determines, based on the resolution of image data included in an input encoded stream, whether partial decoding is to be performed or not. For example, if the resolution of the image data is too high to be supported by the processing performance or the display resolution of the image decoding device 60, the determination section 91 decides to perform the partial decoding. Also, if, for example, the resolution of the image data can be supported by the processing performance or the display resolution of the image decoding device 60, the determination section 91 decides to decode all of the image data. Furthermore, the determination section 91 may determine, based on the header information of the encoded stream, for example, whether image data included in the encoded stream is image data allowing partial decoding or not. Then, the determination section 91 outputs the result of determination to the sorting section 92, the first prediction section 93a and the second prediction section 93b.

The sorting section 92 sorts the reference pixel values included in reference image data supplied from the frame memory 69 according to the rule described in relation to FIG. 10. Then, the sorting section 92 outputs the reference pixel value for a first pixel position (for example, a pixel a) among the sorted reference pixel values to the first prediction section 93a.

Furthermore, in the case decoding of all of the image data is decided by the determination section 91, the sorting section 92 outputs the reference pixel value for a second pixel position (for example, a pixel b) among the sorted reference pixel values to the first prediction section 93a, and also, outputs the reference pixel value for a third pixel position (for example, a pixel c) to the second prediction section 93b. Furthermore, the sorting section 92 outputs the reference pixel value for a fourth pixel position (for example, a pixel d) among the sorted reference pixel values to the first prediction section 93a. Also, the sorting section 92 sorts the predicted pixel values of the first, second, third and fourth pixel positions generated by the first prediction section 93a and the second prediction section 93b into the original order by a reversed process of the example shown in FIG. 9.

The first prediction section 93a includes a first mode buffer 94a and a first prediction calculation section 95a. The first mode buffer 94a acquires prediction mode information included in the information about intra prediction input from the lossless decoding section 62, and temporarily stores the acquired prediction mode information using a storage medium. The prediction mode information includes information indicating the size of a prediction unit which is a processing unit of intra prediction (for example, the intra 4×4 prediction mode, the intra 8×8 prediction mode or the like), for example. Also, the prediction mode information includes information indicating a prediction direction selected as being the optimal at the time of encoding an image, from a plurality of prediction directions, for example. Furthermore, the prediction mode information may include information indicating that estimation of a prediction mode is possible, but in this case, the prediction mode information does not include a prediction mode number indicating the prediction direction. The first prediction calculation section 95a calculates the predicted pixel value of a first pixel position according to the prediction mode information stored in the first mode buffer 94a. At the time of calculating the predicted pixel value of the first pixel position, the first prediction calculation section 95a does not use the correlation with the pixel value of a reference pixel corresponding to another pixel position. Additionally, in the case the prediction mode information indicates that estimation of a prediction mode for the first pixel position is possible, the first prediction calculation section 95a estimates a prediction mode for calculating the predicted pixel value of the first pixel position from the prediction mode selected at the time of calculating the predicted pixel value of the first pixel position of the reference block.

In the case partial decoding is decided by the determination section 91 to be performed, predicted image data including only the predicted pixel value generated by the first prediction section 93a in this manner is output to the selector 71 via the sorting section 92. That is, in this case, the pixel values regarding only the pixels belonging to the first group in FIG. 11 are decoded, and the processes regarding the pixels belonging to the second group and the third group are skipped.

Furthermore, in the case decoding of all of the image data is decided by the determination section 91, the first prediction calculation section 95a further sequentially calculates the predicted pixel values of the second pixel position and the fourth pixel position according to the prediction mode information stored in the first mode buffer 94a. At the time of calculation of the predicted pixel value of the second pixel position, if the prediction mode information indicates Mode 9, for example, the first prediction calculation section 95a may use the correlation with the pixel value of the first pixel position. Also, at the time of calculation of the predicted pixel value of the fourth pixel position, if the prediction mode information indicates Mode 9, for example, the first prediction calculation section 95a may use the correlation with the pixel value of the second pixel position and the correlation with the pixel value of the third pixel position.

The second prediction section 93b includes a second mode buffer 94b and a second prediction calculation section 95b. In the case decoding of all of the image data is decided by the determination section 91, the second prediction calculation section 95b calculates the predicted pixel value of the third pixel position according to the prediction mode information stored in the second mode buffer 94b. Calculation of the predicted pixel value of the second pixel position by the first prediction calculation section 95a and calculation of the predicted pixel value of the third pixel position by the second prediction calculation section 95b are performed in parallel. At the time of calculation of the predicted pixel value of the third pixel position, if the prediction mode information indicates Mode 9, for example, the second prediction calculation section 95b may use the correlation with the pixel value of the first pixel position.

In the case decoding of all of the image data is decided by the determination section 91, the predicted pixel values generated by the first prediction section 93a and the second prediction section 93b in this manner are output to the sorting section 92. Then, the sorting section 92 generates predicted image data by sorting the predicted pixel values into the original order, and outputs the generated predicted image data to the selector 71. That is, in this case, pixel values are decoded not only for the pixels belonging to the first group of FIG. 11, but also for the pixels belonging to the second group and the third group.

### (2) Second Example Configuration

FIG. 22 shows a second example configuration of a decoding side corresponding to the example configuration of the intra prediction section 40 on the encoding side illustrated in FIG. 12. Referring to FIG. 22, the intra prediction section 90 includes a determination section 91, a sorting section 92 and a prediction section 93. Also, the prediction section 93 includes a first prediction section 93a, a second prediction section 93b and a third prediction section 93c that are three processing branches arranged in parallel.

The determination section 91 determines, based on the resolution of image data included in an input encoded stream, whether partial decoding is to be performed or not. Then, the determination section 91 outputs the result of determination to the sorting section 92, the first prediction section 93a, the second prediction section 93b and the third prediction section 93c.

The sorting section 92 sorts the reference pixel values included in reference image data supplied from the frame memory 69 according to the rule described in relation to FIG. 10. Then, the sorting section 92 outputs the reference pixel value for a first pixel position among the sorted reference pixel values to the first prediction section 93a.

Furthermore, in the case decoding of all of the image data is decided by the determination section 91, the sorting section 92 outputs the reference pixel value for a second pixel position among the sorted reference pixel values to the first prediction section 93a, the reference pixel value for a third pixel position to the second prediction section 93b, and the reference pixel value for a fourth pixel position to the third prediction section 93c.

The first prediction calculation section 95a calculates the predicted pixel value of the first pixel position according to the prediction mode information stored in the first mode buffer 94a. At the time of calculation of the predicted pixel value of the first pixel position, the first prediction calculation section 95a does not use the correlation with the pixel value of a reference pixel corresponding to another pixel position.

In the case partial decoding is decided by the determination section 91 to be performed, predicted image data including only the predicted pixel value generated by the first prediction section 93a in this manner is output to the selector 71 via the sorting section 92. That is, in this case, the pixel values regarding only the pixels belonging to the first group in FIG. 13 are decoded, and the process regarding the pixels belonging to the second group is skipped.

Also, in the case decoding of all of the image data is decided by the determination section 91, the first prediction calculation section 95a further calculates the predicted pixel value of the second pixel position according to the prediction mode information stored in the first mode buffer 94a. At the time of calculation of the predicted pixel value of the second pixel position, if the prediction mode information indicates Mode 9, for example, the first prediction calculation section 95a may use the correlation with the pixel value of the first pixel position.

Furthermore, the second prediction calculation section 95b calculates the predicted pixel value of the third pixel position according to the prediction mode information stored in the second mode buffer 94b. At the time of calculation of the predicted pixel value of the third pixel position, if the prediction mode information indicates Mode 9, for example, the second prediction calculation section 95b may use the correlation with the pixel value of the first pixel position.

The third prediction section 93c includes a third mode buffer 94c and a third prediction calculation section 95c. In the case decoding of all of the image data is decided by the determination section 91, the third prediction calculation section 95c calculates the predicted pixel value of the fourth pixel position according to the prediction mode information stored in the third mode buffer 94c. Calculation of the predicted pixel value of the second pixel position by the first prediction calculation section 95a, calculation of the predicted pixel value of the third pixel position by the second prediction calculation section 95b, and calculation of the predicted pixel value of the fourth pixel position by the third prediction calculation section 95c are performed in parallel. At the time of calculation of the predicted pixel value of the fourth pixel position, if the prediction mode information indicates Mode 9, for example, the third prediction calculation section 95c may use the correlation with the pixel value of the first pixel position.

In the case decoding of all of the image data is decided by the determination section 91, the predicted pixel values generated by the first prediction section 93a, the second prediction section 93b and the third prediction section 93c in this manner are output to the sorting section 92. Then, the sorting section 92 generates the predicted image data by sorting the predicted pixel values into the original order, and outputs the generated predicted image data to the selector 71. That is, in this case, not only the pixels belonging to the first group of FIG. 13, but also the pixels belonging to the second group are decoded.

### 4. Flow of Process at the Time of Decoding According to an Embodiment

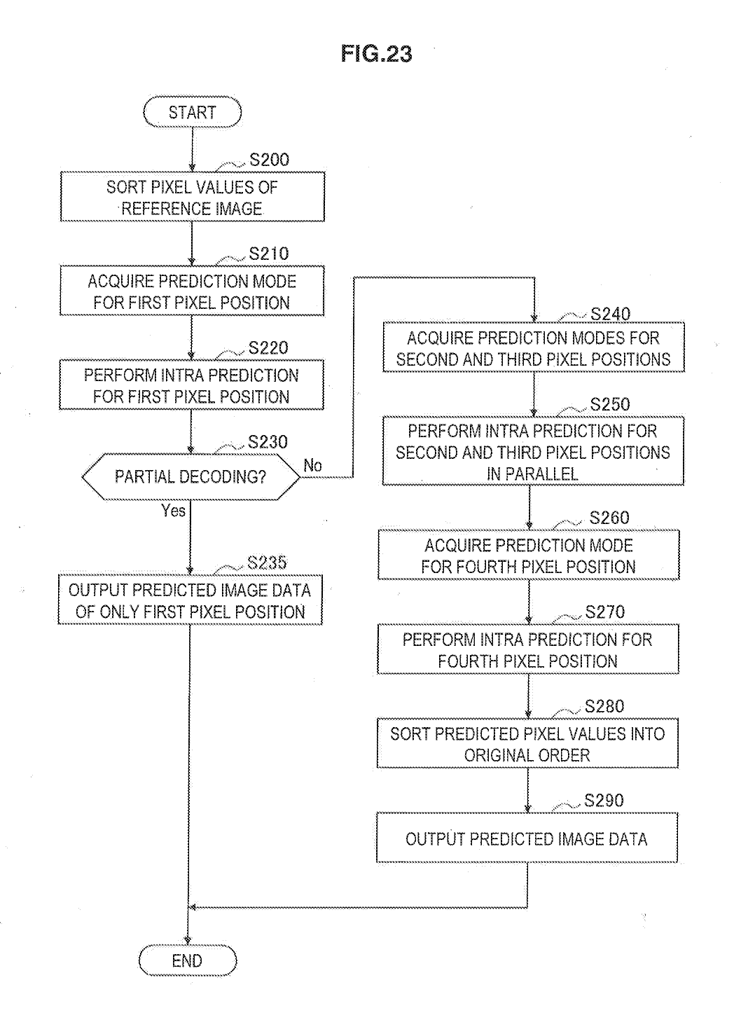

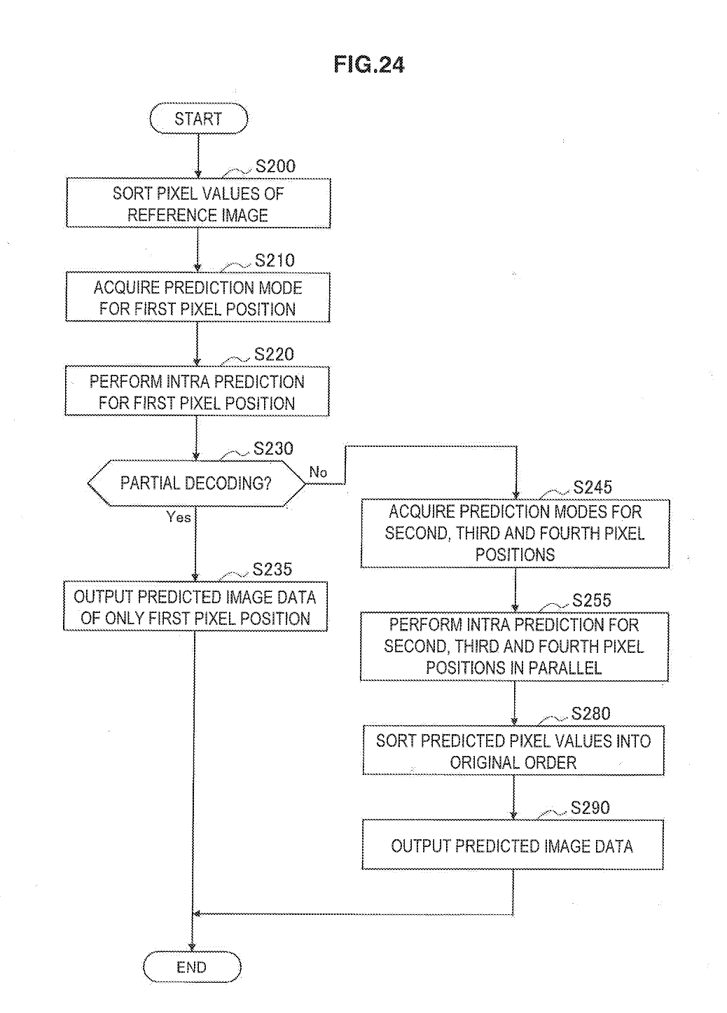

Next, a flow of a process at the time of decoding will be described using FIGS. 23 and 24. FIG. 23 is a flow chart showing an example of a flow of the intra prediction process at the time of decoding of the intra prediction section 90 having the configuration illustrated in FIG. 21.

Referring to FIG. 23, first, the sorting section 92 sorts reference pixel values included in reference image data supplied from the frame memory 69 according to the rule illustrated in FIG. 10 (step S200). Then, the sorting section 92 outputs the reference pixel value for a first pixel position (for example, a pixel a) among the sorted reference pixel values to the first prediction section 93a.

Next, the first prediction section 93a acquires the prediction mode information for the first pixel position input from the lossless decoding section 62 (step S210). Then, the first prediction section 93a performs the intra prediction process for the first pixel position according to the prediction mode indicated by the acquired prediction mode information, and generates a predicted pixel value (step S220).

Furthermore, the determination section 91 determines, based on the resolution of image data included in an input encoded stream, whether partial decoding is to be performed or not (step S230). If the determination section 91 decides here that partial decoding is to be performed, predicted image data including the pixel value of only the first pixel position is output to the selector 71 via the sorting section 92 (step S235). On the other hand, if it is decided that partial decoding is not to be performed, that is, if it is decided that all of the image data is to be decoded, the process proceeds to step S240.

In step S240, the first prediction section 93a acquires the prediction mode information for a second pixel position (for example, a pixel b), and also, the second prediction section 93b acquires the prediction mode information for a third pixel position (for example, a pixel c) (step S240). Furthermore, the sorting section 92 outputs the reference pixel value for the second pixel position among the sorted reference pixel values to the first prediction section 93a. Also, the sorting section 92 outputs the reference pixel value for the third pixel position among the sorted reference pixel values to the second prediction section 93b. Then, the intra prediction process for the second pixel position by the first prediction section 93a and the intra prediction process for the third pixel position by the second prediction section 93b are performed in parallel, and predicted pixel values are generated (step S250).

Next, the first prediction section 93a acquires the prediction mode information for a fourth pixel position (for example, a pixel d) (step S260). Also, the sorting section 92 outputs the reference pixel value for the fourth pixel position among the sorted reference pixel values to the first prediction section 93a. Then, the first prediction section 93a performs the intra prediction process for the fourth pixel position, and generates a predicted pixel value (step S270).

Then, the sorting section 92 generates predicted image data by sorting the predicted pixel values of the first, second, third and fourth pixel positions generated by the first prediction section 93a and the second prediction section 93b into the original order (step S280). Then, the sorting section 92 outputs the generated predicted pixel data to the selector 71 (step S290).

FIG. 24 is a flow chart showing an example of a flow of the intra prediction process at the time of decoding of the intra prediction section 90 having the configuration illustrated in FIG. 22.

Referring to FIG. 24, the process from step S200 to step S230 is the same as in FIG. 23. If partial decoding is decide in step S230 by the determination section 91 to be performed, predicted image data including only the pixel value of a first pixel position is output to the selector 71 via the sorting section 92 (step S235). On the other hand, if it is decided that partial decoding is not to be performed, that is, if it is decided that all of the image data is to be decoded, the process proceeds to step S245.

In step S245, the first prediction section 93a acquires the prediction mode information for a second pixel position, the second prediction section 93b acquires the prediction mode information for a third pixel position, and the third prediction section 93c acquires the prediction mode information for a fourth pixel position (step S245). Then, the intra prediction process for the second pixel position by the first prediction section 93a, the intra prediction process for the third pixel position by the second prediction section 93b, and the intra prediction process for the fourth pixel position by the third prediction section 93c are performed in parallel, and predicted pixel values are generated (step S255).

Then, the sorting section 92 generates predicted image data by sorting the predicted pixel values of the first, second, third and fourth pixel positions generated by the first prediction section 93a, the second prediction section 93b and the third prediction section 93c into the original order (step S280). Then, the sorting section 92 outputs the generated predicted pixel data to the selector 71 (step S290).

### 5. Example Application

The image encoding device 10 and the image decoding device 60 according to the embodiment described above may be applied to various electronic appliances such as a transmitter and a receiver for satellite broadcasting, cable broadcasting such as cable TV, distribution on the Internet, distribution to terminals via cellular communication, and the like, a recording device that records images in a medium such as an optical disc, a magnetic disk or a flash memory, a reproduction device that reproduces images from such storage medium, and the like. Four example applications will be described below.

### 5-1. First Example Application

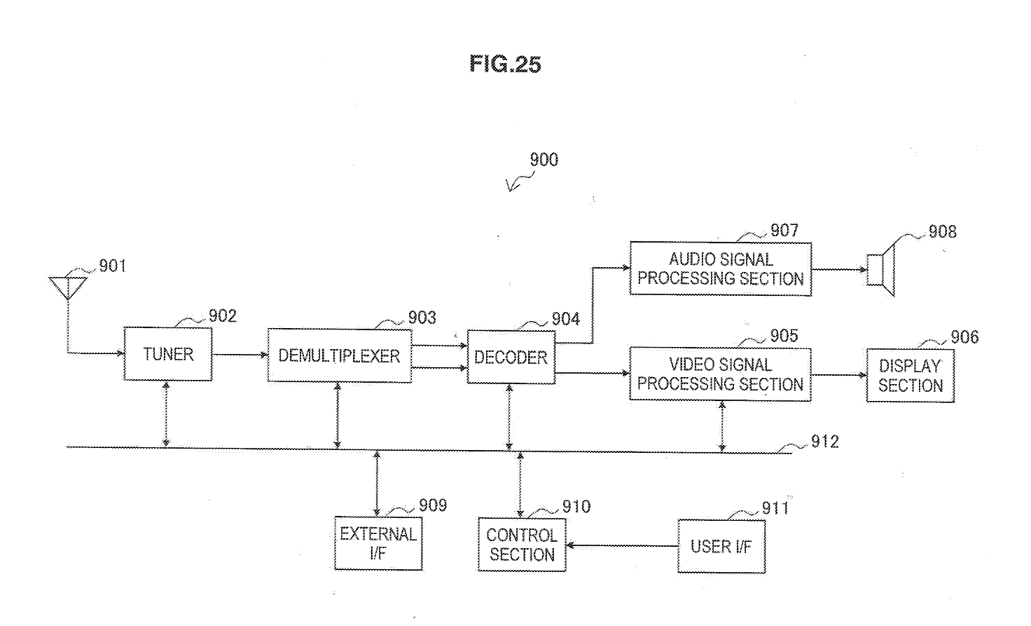

FIG. 25 is a block diagram showing an example of a schematic configuration of a television adopting the embodiment described above. A television 900 includes an antenna 901, a tuner 902, a demultiplexer 903, a decoder 904, an video signal processing section 905, a display section 906, an audio signal processing section 907, a speaker 908, an external interface 909, a control section 910, a user interface 911, and a bus 912.

The tuner 902 extracts a signal of a desired channel from broadcast signals received via the antenna 901, and demodulates the extracted signal. Then, the tuner 902 outputs an encoded bit stream obtained by demodulation to the demultiplexer 903. That is, the tuner 902 serves as transmission means of the televisions 900 for receiving an encoded stream in which an image is encoded.

The demultiplexer 903 separates a video stream and an audio stream of a program to be viewed from the encoded bit stream, and outputs each stream which has been separated to the decoder 904. Also, the demultiplexer 903 extracts auxiliary data such as an EPG (Electronic Program Guide) from the encoded bit stream, and supplies the extracted data to the control section 910. Additionally, the demultiplexer 903 may perform descrambling in the case the encoded bit stream is scrambled.

The decoder 904 decodes the video stream and the audio stream input from the demultiplexer 903. Then, the decoder 904 outputs video data generated by the decoding process to the video signal processing section 905. Also, the decoder 904 outputs the audio data generated by the decoding process to the audio signal processing section 907.

The video signal processing section 905 reproduces the video data input from the decoder 904, and causes the display section 906 to display the video. The video signal processing section 905 may also cause the display section 906 to display an application screen supplied via a network. Further, the video signal processing section 905 may perform an additional process such as noise removal, for example, on the video data according to the setting. Furthermore, the video signal processing section 905 may generate an image of a GUI (Graphical User Interface) such as a menu, a button, a cursor or the like, for example, and superimpose the generated image on an output image.

The display section 906 is driven by a drive signal supplied by the video signal processing section 905, and displays a video or an image on an video screen of a display device (for example, a liquid crystal display, a plasma display, an OLED, or the like).

The audio signal processing section 907 performs reproduction processes such as D/A conversion and amplification on the audio data input from the decoder 904, and outputs audio from the speaker 908. Also, the audio signal processing section 907 may perform an additional process such as noise removal on the audio data.

The external interface 909 is an interface for connecting the television 900 and an external appliance or a network. For example, a video stream or an audio stream received via the external interface 909 may be decoded by the decoder 904. That is, the external interface 909 also serves as transmission means of the televisions 900 for receiving an encoded stream in which an image is encoded.

The control section 910 includes a processor such as a CPU (Central Processing Unit), and a memory such as an RAM (Random Access Memory), an ROM (Read Only Memory), or the like. The memory stores a program to be executed by the CPU, program data, EPG data, data acquired via a network, and the like. The program stored in the memory is read and executed by the CPU at the time of activation of the television 900, for example. The CPU controls the operation of the television 900 according to an operation signal input from the user interface 911, for example, by executing the program.

The user interface 911 is connected to the control section 910. The user interface 911 includes a button and a switch used by a user to operate the television 900, and a receiving section for a remote control signal, for example. The user interface 911 detects an operation of a user via these structural elements, generates an operation signal, and outputs the generated operation signal to the control section 910.

The bus 912 interconnects the tuner 902, the demultiplexer 903, the decoder 904, the video signal processing section 905, the audio signal processing section 907, the external interface 909, and the control section 910.

In the television 900 configured in this manner, the decoder 904 has a function of the image decoding device 60 according to the embodiment described above. Accordingly, in the television 900, it is possible to partially decode in the intra prediction mode.

### 5-2. Second Example Application

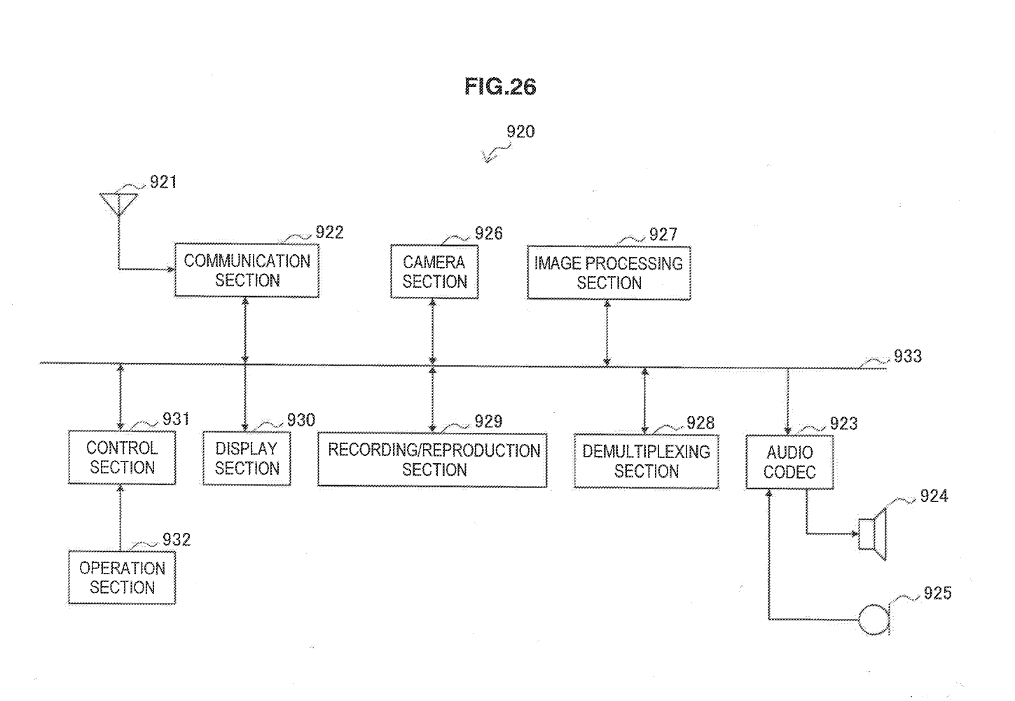

FIG. 26 is a block diagram showing an example of a schematic configuration of a mobile phone adopting the embodiment described above. A mobile phone 920 includes an antenna 921, a communication section 922, an audio codec 923, a speaker 924, a microphone 925, a camera section 926, an image processing section 927, a demultiplexing section 928, a recording/reproduction section 929, a display section 930, a control section 931, an operation section 932, and a bus 933.

The antenna 921 is connected to the communication section 922. The speaker 924 and the microphone 925 are connected to the audio codec 923. The operation section 932 is connected to the control section 931. The bus 933 interconnects the communication section 922, the audio codec 923, the camera section 926, the image processing section 927, the demultiplexing section 928, the recording/reproduction section 929, the display section 930, and the control section 931.

The mobile phone 920 performs operation such as transmission/reception of audio signal, transmission/reception of emails or image data, image capturing, recording of data, and the like, in various operation modes including an audio communication mode, a data communication mode, an image capturing mode, and a videophone mode.

In the audio communication mode, an analogue audio signal generated by the microphone 925 is supplied to the audio codec 923. The audio codec 923 converts the analogue audio signal into audio data, and A/D converts and compresses the converted audio data. Then, the audio codec 923 outputs the compressed audio data to the communication section 922. The communication section 922 encodes and modulates the audio data, and generates a transmission signal. Then, the communication section 922 transmits the generated transmission signal to a base station (not shown) via the antenna 921. Also, the communication section 922 amplifies a wireless signal received via the antenna 921 and converts the frequency of the wireless signal, and acquires a received signal. Then, the communication section 922 demodulates and decodes the received signal and generates audio data, and outputs the generated audio data to the audio codec 923. The audio codec 923 extends and D/A converts the audio data, and generates an analogue audio signal. Then, the audio codec 923 supplies the generated audio signal to the speaker 924 and causes the audio to be output.

Also, in the data communication mode, the control section 931 generates text data that makes up an email, according to an operation of a user via the operation section 932, for example. Moreover, the control section 931 causes the text to be displayed on the display section 930. Furthermore, the control section 931 generates email data according to a transmission instruction of the user via the operation section 932, and outputs the generated email data to the communication section 922. Then, the communication section 922 encodes and modulates the email data, and generates a transmission signal. Then, the communication section 922 transmits the generated transmission signal to a base station (not shown) via the antenna 921. Also, the communication section 922 amplifies a wireless signal received via the antenna 921 and converts the frequency of the wireless signal, and acquires a received signal. Then, the communication section 922 demodulates and decodes the received signal, restores the email data, and outputs the restored email data to the control section 931. The control section 931 causes the display section 930 to display the contents of the email, and also, causes the email data to be stored in the storage medium of the recording/reproduction section 929.

The recording/reproduction section 929 includes an arbitrary readable and writable storage medium. For example, the storage medium may be a built-in storage medium such as an RAM, a flash memory or the like, or an externally mounted storage medium such as a hard disk, a magnetic disk, a magneto-optical disk, an optical disc, an USB memory, a memory card, or the like.

Furthermore, in the image capturing mode, the camera section 926 captures an image of a subject, generates image data, and outputs the generated image data to the image processing section 927, for example. The image processing section 927 encodes the image data input from the camera section 926, and causes the encoded stream to be stored in the storage medium of the recording/reproduction section 929.

Furthermore, in the videophone mode, the demultiplexing section 928 multiplexes a video stream encoded by the image processing section 927 and an audio stream input from the audio codec 923, and outputs the multiplexed stream to the communication section 922, for example. The communication section 922 encodes and modulates the stream, and generates a transmission signal. Then, the communication section 922 transmits the generated transmission signal to a base station (not shown) via the antenna 921. Also, the communication section 922 amplifies a wireless signal received via the antenna 921 and converts the frequency of the wireless signal, and acquires a received signal. These transmission signal and received signal may include an encoded bit stream. Then, the communication section 922 demodulates and decodes the received signal, restores the stream, and outputs the restored stream to the demultiplexing section 928. The demultiplexing section 928 separates a video stream and an audio stream from the input stream, and outputs the video stream to the image processing section 927 and the audio stream to the audio codec 923. The image processing section 927 decodes the video stream, and generates video data. The video data is supplied to the display section 930, and a series of images is displayed by the display section 930. The audio codec 923 extends and D/A converts the audio stream, and generates an analogue audio signal. Then, the audio codec 923 supplies the generated audio signal to the speaker 924 and causes the audio to be output.

In the mobile phone 920 configured in this manner, the image processing section 927 has a function of the image encoding device 10 and the image decoding device 60 according to the embodiment described above. Accordingly, in the mobile phone 920, and other apparatus which communicates with the mobile phone 920, it is possible to partially decode in the intra prediction mode.

### 5-3. Third Example Application

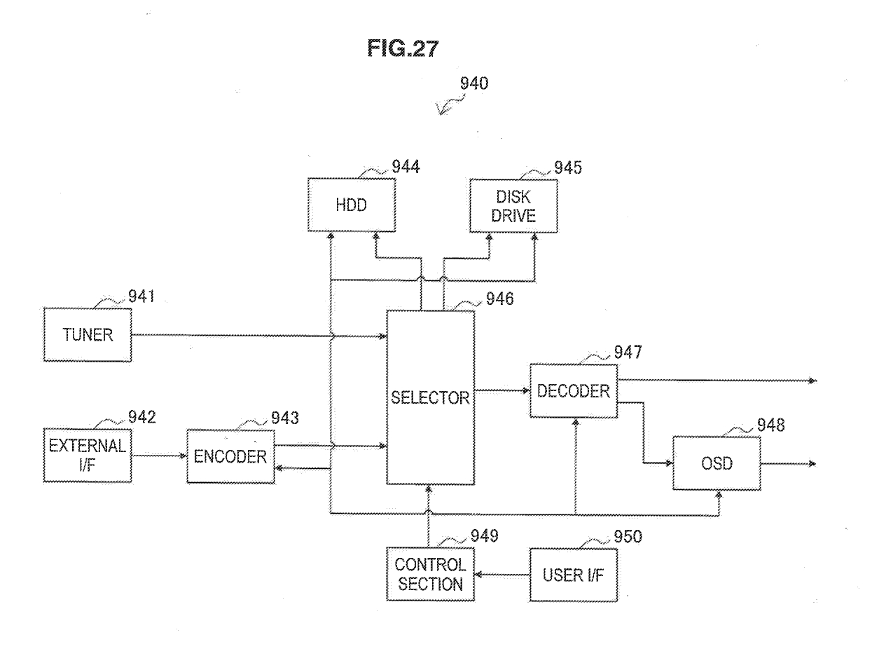

FIG. 27 is a block diagram showing an example of a schematic configuration of a recording/reproduction device adopting the embodiment described above. A recording/reproduction device 940 encodes, and records in a recording medium, audio data and video data of a received broadcast program, for example. The recording/reproduction device 940 may also encode, and record in the recording medium, audio data and video data acquired from another device, for example. Furthermore, the recording/reproduction device 940 reproduces, using a monitor or a speaker, data recorded in the recording medium, according to an instruction of a user, for example. At this time, the recording/reproduction device 940 decodes the audio data and the video data.

The recording/reproduction device 940 includes a tuner 941, an external interface 942, an encoder 943, an HDD (Hard Disk Drive) 944, a disc drive 945, a selector 946, a decoder 947, an OSD (On-Screen Display) 948, a control section 949, and a user interface 950.

The tuner 941 extracts a signal of a desired channel from broadcast signals received via an antenna (not shown), and demodulates the extracted signal. Then, the tuner 941 outputs an encoded bit stream obtained by demodulation to the selector 946. That is, the tuner 941 serves as transmission means of the recording/reproduction device 940.

The external interface 942 is an interface for connecting the recording/reproduction device 940 and an external appliance or a network. For example, the external interface 942 may be an IEEE 1394 interface, a network interface, an USB interface, a flash memory interface, or the like. For example, video data and audio data received by the external interface 942 are input to the encoder 943. That is, the external interface 942 serves as transmission means of the recording/reproduction device 940.

In the case the video data and the audio data input from the external interface 942 are not encoded, the encoder 943 encodes the video data and the audio data. Then, the encoder 943 outputs the encoded bit stream to the selector 946.

The HDD 944 records in an internal hard disk an encoded bit stream, which is compressed content data of a video or audio, various programs, and other pieces of data. Also, the HDD 944 reads these pieces of data from the hard disk at the time of reproducing a video or audio.

The disc drive 945 records or reads data in a recording medium that is mounted. A recording medium that is mounted on the disc drive 945 may be a DVD disc (a DVD-Video, a DVD-RAM, a DVD-R, a DVD-RW, a DVD+, a DVD+RW, or the like), a Blu-ray (registered trademark) disc, or the like, for example.

The selector 946 selects, at the time of recording a video or audio, an encoded bit stream input from the tuner 941 or the encoder 943, and outputs the selected encoded bit stream to the HDD 944 or the disc drive 945. Also, the selector 946 outputs, at the time of reproducing a video or audio, an encoded bit stream input from the HDD 944 or the disc drive 945 to the decoder 947.

The decoder 947 decodes the encoded bit stream, and generates video data and audio data. Then, the decoder 947 outputs the generated video data to the OSD 948. Also, the decoder 904 outputs the generated audio data to an external speaker.

The OSD 948 reproduces the video data input from the decoder 947, and displays a video. Also, the OSD 948 may superimpose an image of a GUT, such as a menu, a button, a cursor or the like, for example, on a displayed video.

The control section 949 includes a processor such as a CPU, and a memory such as an RAM or an ROM. The memory stores a program to be executed by the CPU, program data, and the like. A program stored in the memory is read and executed by the CPU at the time of activation of the recording/reproduction device 940, for example. The CPU controls the operation of the recording/reproduction device 940 according to an operation signal input from the user interface 950, for example, by executing the program.

The user interface 950 is connected to the control section 949. The user interface 950 includes a button and a switch used by a user to operate the recording/reproduction device 940, and a receiving section for a remote control signal, for example. The user interface 950 detects an operation of a user via these structural elements, generates an operation signal, and outputs the generated operation signal to the control section 949.

In the recording/reproduction device 940 configured in this manner, the encoder 943 has a function of the image encoding device 10 according to the embodiment described above. Also, the decoder 947 has a function of the image decoding device 60 according to the embodiment described above. Accordingly, in the recording/reproduction device 940, and other apparatus using video output from the recording/reproduction device 940, it is possible to partially decode in the intra prediction mode.

### 5-4. Fourth Example Application

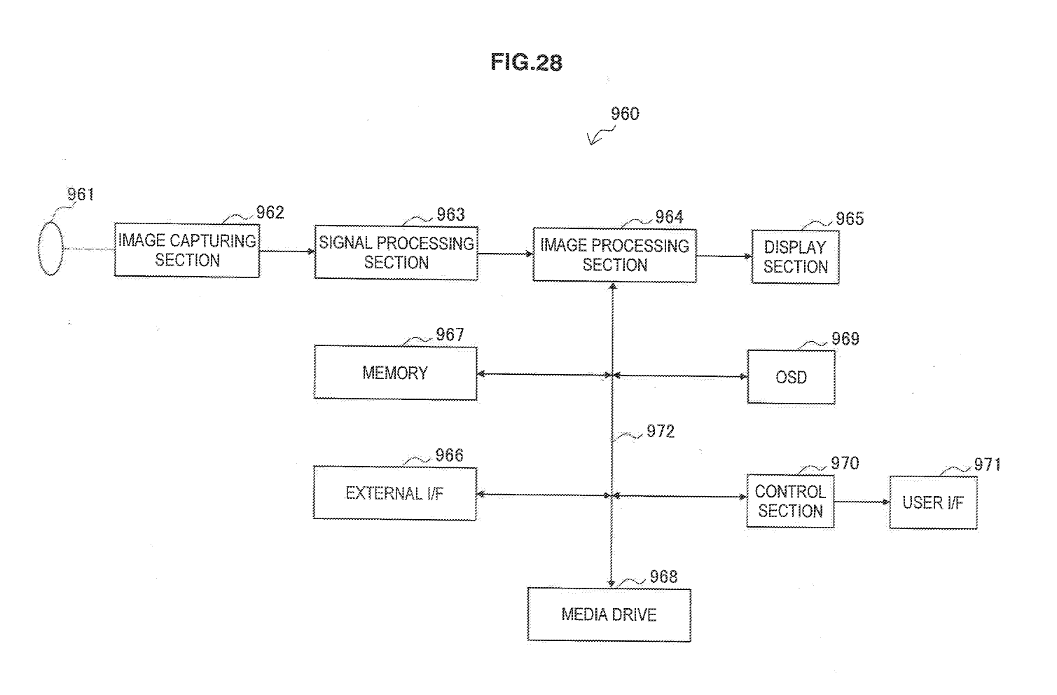

FIG. 28 is a block diagram showing an example of a schematic configuration of an image capturing device adopting the embodiment described above. An image capturing device 960 captures an image of a subject, generates an image, encodes the image data, and records the image data in a recording medium.

The image capturing device 960 includes an optical block 961, an image capturing section 962, a signal processing section 963, an image processing section 964, a display section 965, an external interface 966, a memory 967, a media drive 968, an OSD 969, a control section 970, a user interface 971, and a bus 972.

The optical block 961 is connected to the image capturing section 962. The image capturing section 962 is connected to the signal processing section 963. The display section 965 is connected to the image processing section 964. The user interface 971 is connected to the control section 970. The bus 972 interconnects the image processing section 964, the external interface 966, the memory 967, the media drive 968, the OSD 969, and the control section 970.

The optical block 961 includes a focus lens, an aperture stop mechanism, and the like. The optical block 961 forms an optical image of a subject on an image capturing surface of the image capturing section 962. The image capturing section 962 includes an image sensor such as a CCD, a CMOS or the like, and converts by photoelectric conversion the optical image formed on the image capturing surface into an image signal which is an electrical signal. Then, the image capturing section 962 outputs the image signal to the signal processing section 963.

The signal processing section 963 performs various camera signal processes, such as knee correction, gamma correction, color correction and the like, on the image signal input from the image capturing section 962. The signal processing section 963 outputs the image data after the camera signal process to the image processing section 964.

The image processing section 964 encodes the image data input from the signal processing section 963, and generates encoded data. Then, the image processing section 964 outputs the generated encoded data to the external interface 966 or the media drive 968. Also, the image processing section 964 decodes encoded data input from the external interface 966 or the media drive 968, and generates image data. Then, the image processing section 964 outputs the generated image data to the display section 965. Also, the image processing section 964 may output the image data input from the signal processing section 963 to the display section 965, and cause the image to be displayed. Furthermore, the image processing section 964 may superimpose data for display acquired from the OSD 969 on an image to be output to the display section 965.

The OSD 969 generates an image of a GUI, such as a menu, a button, a cursor or the like, for example, and outputs the generated image to the image processing section 964.

The external interface 966 is configured as an USB input/output terminal, for example. The external interface 966 connects the image capturing device 960 and a printer at the time of printing an image, for example. Also, a drive is connected to the external interface 966 as necessary. A removable medium, such as a magnetic disk, an optical disc or the like, for example, is mounted on the drive, and a program read from the removable medium may be installed in the image capturing device 960. Furthermore, the external interface 966 may be configured as a network interface to be connected to a network such as a LAN, the Internet or the like. That is, the external interface 966 serves as transmission means of the image capturing device 960.

A recording medium to be mounted on the media drive 968 may be an arbitrary readable and writable removable medium, such as a magnetic disk, a magneto-optical disk, an optical disc, a semiconductor memory or the like, for example. Also, a recording medium may be fixedly mounted on the media drive 968, configuring a non-transportable storage section such as a built-in hard disk drive or an SSD (Solid State Drive), for example.

The control section 970 includes a processor such as a CPU, and a memory such as an RAM or an ROM. The memory stores a program to be executed by the CPU, program data, and the like. A program stored in the memory is read and executed by the CPU at the time of activation of the image capturing device 960, for example. The CPU controls the operation of the image capturing device 960 according to an operation signal input from the user interface 971, for example, by executing the program.

The user interface 971 is connected to the control section 970. The user interface 971 includes a button, a switch and the like used by a user to operate the image capturing device 960, for example. The user interface 971 detects an operation of a user via these structural elements, generates an operation signal, and outputs the generated operation signal to the control section 970.

In the image capturing device 960 configured in this manner, the image processing section 964 has a function of the image encoding device 10 and the image decoding device 60 according to the embodiment described above. Accordingly, in the image capturing device 960, and other apparatus using video output from the image capturing device 950, it is possible to partially decode in the intra prediction mode.

### 6. Summary

Heretofore, the image encoding device 10 and the image decoding device 60 according to an embodiment have been described using FIGS. 1 to 28. According to present embodiment, at the time of encoding an image in the intra prediction mode, after pixels of common pixel positions in adjacent sub-blocks are sorted such that they are adjacent to one another after the sorting, the predicted pixel value for the pixel of a first pixel position is generated without using the correlation with the pixel value of another pixel position. Also, at the time of decoding the image, after the pixel values of reference pixels in the image are sorted in the same manner, the predicted pixel value of at least the pixel of the first pixel position is generated without using the correlation with the pixel value of a reference pixel corresponding to another pixel position. Therefore, in the intra prediction mode, partial decoding of decoding the pixel of only the first pixel position and not all of the image is enabled. Also, a prediction unit is formed only by the pixels of the first pixel positions gathered by the sorting, and the intra prediction is performed for each prediction unit. Thus, also in the case of taking only the pixel of the first pixel position as the prediction target, various prediction modes same as those of the existing intra prediction scheme can be adopted.

Also, according to the present embodiment, the predicted pixel value for the pixel of a second pixel position may be generated according to the prediction mode that is based on the correlation with the pixel value of the adjacent first pixel position. Likewise, the predicted pixel value for the pixel of a third pixel position may be generated according to the prediction mode that is based on the correlation with the pixel value of the adjacent first pixel position. Also, the predicted pixel value for the pixel of a fourth pixel position may be generated according to a prediction mode that is based on the correlation with the pixel values of the adjacent second and third pixel positions or the correlation with the pixel value of the first pixel position. That is, since a prediction mode that is based on the correlation between pixels that are close to each other can be used, the accuracy of the intra prediction can be increased, and the coding efficiency can be increased than the existing scheme.

Furthermore, according to the present embodiment, the generation of the predicted pixel value of the second pixel position and the generation of the predicted pixel value of the third pixel value may be performed in parallel. The generation of the predicted pixel value of the fourth pixel position may also be performed in parallel with the generation of the predicted pixel value of the second pixel position and the generation of the predicted pixel value of the third pixel position. The processing speed of the image encoding process and the image decoding process can thereby be increased.

Furthermore, according to the present embodiment, also in the case of realizing partial decoding of only the first pixel position, the increase in the bit rate may be suppressed by using an estimated prediction mode.

Additionally, in the present specification, an example where the size of the sub-block is 2×2 pixels has been mainly described. However, a sub-block having a size 4×4 pixels or larger may also be used. For example, in the case the size of a sub-block is 4×4 pixels, one sub-block includes sixteen types of pixel positions. In this case, in addition to the partial decoding of only the first pixel position, partial decoding of only the first to fourth pixel positions is also possible. That is, if the size of a sub-block is increased, the scalability of partial decoding can be extended.

Additionally, in the present specification, an example has been mainly described where the information about intra prediction and the information about inter prediction is multiplexed to the header of the encoded stream, and the encoded stream is transmitted from the encoding side to the decoding side. However, the method of transmitting this information is not limited to such an example. For example, this information may be transmitted or recorded as individual data that is associated with an encoded bit stream, without being multiplexed to the encoded bit stream. The term “associate” here means to enable an image included in a bit stream (or a part of an image, such as a slice or a block) and information corresponding to the image to link to each other at the time of decoding. That is, this information may be transmitted on a different transmission line from the image (or the bit stream). Or, this information may be recorded on a different recording medium (or in a different recording area on the same recording medium) from the image (or the bit stream). Furthermore, this information and the image (or the bit stream) may be associated with each other on the basis of arbitrary units such as a plurality of frames, one frame, a part of a frame or the like, for example.

Heretofore, a preferred embodiment of the present disclosure has been described in detail while referring to the appended drawings, but the technical scope of the present disclosure is not limited to such an example. It is apparent that a person having an ordinary skill in the art of the technology of the present disclosure may make various alterations or modifications within the scope of the technical ideas described in the claims, and these are, of course, understood to be within the technical scope of the present disclosure.

### REFERENCE SIGNS LIST

10 Image encoding device (Image processing device)
41 Sorting section
42 Prediction section
60 Image decoding device (Image processing device)
91 Determination section
92 Sorting section
93 Prediction section

1. An image processing device comprising:
a sorting section that sorts pixel values of common pixel positions in adjacent sub-blocks included in a block in an image in a manner that the pixel values included in the block are adjacent to one another after the sorting; and
a prediction section that generates a predicted pixel value for a pixel of a first pixel position of the sub-block using the pixel values sorted by the sorting section and a reference pixel value in the image corresponding to the first pixel position.

2. The image processing device according to claim 1, wherein the prediction section generates the predicted pixel value for the pixel of the first pixel position without using a correlation with a pixel value of another pixel position.

3. The image processing device according to claim 2, wherein the prediction section generates a predicted pixel value for a pixel of a second pixel position according to a prediction mode that is based on a correlation with the pixel value of the first pixel position.

4. The image processing device according to claim 3, wherein the prediction section generates a predicted pixel value for a pixel of a third pixel position in parallel with generation of the predicted pixel value for the pixel of the second pixel position, according to the prediction mode that is based on a correlation with the pixel value of the first pixel position.

5. The image processing device according to claim 4, wherein the prediction section generates a predicted pixel value for a pixel of a fourth pixel position in parallel with generation of the predicted pixel values for the pixels of the second pixel position and the third pixel position, according to the prediction mode that is based on a correlation with the pixel value of the first pixel position.

6. The image processing device according to claim 4, wherein the prediction section generates the predicted pixel value for the pixel of the fourth pixel position according to a prediction mode that is based on a correlation with the pixel values of the second pixel position and the third pixel position.

7. The image processing device according to claim 1, wherein, in a case where a prediction mode selected at a time of generating the predicted pixel value for the pixel of the first pixel position is allowed to be estimated from a prediction mode selected at a time of generating a predicted pixel value of the first pixel position of another block that is already encoded, the prediction section generates information indicating that the prediction mode for the first pixel position is allowed to be estimated.

8. The image processing device according to claim 3, wherein the prediction mode that is based on a correlation with the pixel value of the first pixel position is a prediction mode of generating the predicted pixel value by phase-shifting the pixel value of the first pixel position.

9. An image processing method for processing an image, comprising:
sorting pixel values of common pixel positions in adjacent sub-blocks included in a block in an image in a manner that the pixel values included in the block are adjacent to one another after the sorting; and
generating a predicted pixel value for a pixel of a first pixel position of the sub-block using the sorted pixel values and a reference pixel value in the image corresponding to the first pixel position.

10. An image processing device comprising:
a sorting section that sorts pixel values of reference pixels corresponding to respective common pixel positions in adjacent sub-blocks included in a block in an image in a manner that the pixel values of the reference pixels in the image are adjacent to one another after the sorting; and
a prediction section that generates a predicted pixel value for a pixel of a first pixel position of the sub-block using the pixel values of the reference pixels sorted by the sorting section.

11. The image processing device according to claim 10, wherein the prediction section generates the predicted pixel value for the pixel of the first pixel position without using a correlation with a pixel value of a reference pixel corresponding to another pixel position.

12. The image processing device according to claim 11, wherein the prediction section generates a predicted pixel value for a pixel of a second pixel position according to a prediction mode that is based on a correlation with the pixel value of the first pixel position.

13. The image processing device according to claim 12, wherein the prediction section generates a predicted pixel value for a pixel of a third pixel position in parallel with generation of the predicted pixel value for the pixel of the second pixel position, according to the prediction mode that is based on a correlation with the pixel value of the first pixel position.

14. The image processing device according to claim 13, wherein the prediction section generates a predicted pixel value for a pixel of a fourth pixel position in parallel with generation of the predicted pixel values for the pixels of the second pixel position and the third pixel position, according to the prediction mode that is based on a correlation with the pixel value of the first pixel position.

15. The image processing device according to claim 13, wherein the prediction section generates the predicted pixel value for the pixel of the fourth pixel position according to a prediction mode that is based on a correlation with the pixel values of the second pixel position and the third pixel position.

16. The image processing device according to claim 10, wherein, in a case where it is indicated that a prediction mode is allowed to be estimated for the first pixel position, the prediction section estimates the prediction mode for generating the predicted pixel value for the pixel of the first pixel position from a prediction mode selected at a time of generating a predicted pixel value of the first pixel position of another block that is already encoded.

17. The image processing device according to claim 12, wherein the prediction mode that is based on a correlation with the pixel value of the first pixel position is a prediction mode of generating the predicted pixel value by phase-shifting the pixel value of the first pixel position.

18. The image processing device according to claim 10, further comprising:
a determination section that determines whether to partially decode the image or not,
wherein, in a case where the determination section determines that the image is to be partially decoded, the prediction section does not generate a predicted pixel value of at least one pixel position excluding the first pixel position.

19. An image processing method for processing an image, comprising:
sorting pixel values of reference pixels corresponding to respective common pixel positions in adjacent sub-blocks included in a block in an image in a manner that the pixel values of the reference pixels in the image are adjacent to one another after the sorting; and
generating a predicted pixel value for a pixel of a first pixel position of the sub-block using the sorted pixel values of the reference pixels.
